(19) United States
(12) Patent Application Publication
(10) Pub. No.: US 2018/0249361 A1
(43) Pub. Date: Aug. 30, 2018

(54) NETWORK NODE, COMMUNICATION SYSTEM, TERMINAL, NETWORK CONTROL METHOD, AND NON-TRANSITORY MEDIUM

(71) Applicant: NEC CORPORATION, Tokyo (JP)

(72) Inventors: Hiroto OTSUKI, Tokyo (JP); Toshiyasu KURASUGI, Tokyo (JP)

(73) Assignee: NEC CORPORATION, Tokyo (JP)

(21) Appl. No.: 15/754,644

(22) PCT Filed: Aug. 31, 2015
(86) PCT No.: PCT/JP2015/074758

§ 371 Date: Feb. 23, 2018

(51) Int. Cl. H04W 24/10; H04W 4/70; H04W 24/02; H04W 64/00

(52) U.S. Cl. CPC H04W 24/10; H04W 64/006; H04W 24/02; H04W 4/70

(57) ABSTRACT

A network node includes at least a reception unit that collects information used for determining proximity of a plurality of terminals; and a control unit that operates to select at least one terminal that executes measurement report, from among the plurality of terminals, based on the collected information.

### CROSS REFERENCE TO RELATED APPLICATIONS

This application is a National Stage of International Application No. PCT/JP2015/074758 filed Aug. 31, 2015.

### FIELD

The present invention relates to a network node, a communication system, a terminal, a network control method, and a non-transitory medium.

### BACKGROUND

In recent years, such services, called IoT (Internet of Things) or IoE (Internet of Everything), have begun to draw attention. These services are aimed at providing an added value, by connecting not only conventional communication apparatuses but also every “Thing” to a network. According to these techniques, the network accommodates enormous number of “Things”.

Minimization of Drive Tests (MDT) performed by an operator that manages and operates a network is specified in 3GPP (Third Generation Partnership Project) (for example, Non-Patent Literature 1 (3 GPP TS 32.422 V 12; 4.0), Non-Patent Literature 2 (3 GPP TS 37.320 V 12.2.0)).

In the MDT, there are specified an immediate MDT and a logged MDT. In the immediate MDT, a terminal in an RRC (Radio Resource Control) connected state executes measurement and immediately reports a measurement result to a radio network. In the logged MDT, a terminal in an RRC idle state executes measurement and logging (log), and then, when the terminal enters in an RRC connected state, the terminal reports a measurement result to the radio network. A radio access network to which the terminal (UE) reports includes, for example, a base station (evolved Node B: eNB) of E-UTRAN (Evolved Universal Terrestrial Radio Access Network), an RNC (Radio Network Controller) of UTRAN. Hereinafter, an eNodeB of E-UTRAN, or a Node B and an RNC of UTRAN may be referred to as “eNB/RNC”.

In the logged MDT, for example, when a terminal is in an idle mode (RRC Idle Mode, RRC idle state), the terminal performs measurement and logging of a cell, such as a CSG (Closed Subscriber Group) cell, to which the terminal cannot belong, or a cell of other PLMN (Public Land Mobile Network). When returning to an RRC connected mode (RRC connected state), the terminal reports the logged measurement result.

In an area based MDT, measurement is performed by the terminal served in a cell indicated by UTRAN/E-UTRAN or in a location registration area (Location Area (LA), Routing Area (RA), and Tracking Area (TA)). Furthermore, in a signaling based (subscription based) MDT, measurement data is collected for a specific subscriber, wherein an OAM (Operations, Administration, and Maintenance) selects the terminal that performs the measurement in the signaling based MDT.

Regarding MDT, Patent Literature 1 discloses a technique in which enables a radio network to determine a cause of a radio coverage failure detected by a radio terminal (UE), and to determine and execute an action according to the determination result of the cause. In addition, In Patent Literature 2, a terminal is notified of configuration information related to at least one of collection of measurement information by the terminal and reporting of measurement information to a radio network. On reception of a status of at least one of collection of measurement information by the terminal and reporting of measurement information to a radio network, it is determined whether to re-configure the configuration information or not, thereby making it possible to reduce load on the terminal and to reduce reporting of information with low necessity. Patent Literature 3 discloses a server that saves a load in a drive test of a terminal.

### [Patent Literature 1]

International Publication No. WO2012/043796A1

### [Patent Literature 2]

International Publication No. WO2011/083801A1

### [Patent Literature 2]

Japanese Patent Kokai Publication No. JP2014-150557A1

### [Non-Patent Literature 1]

3GPP TS 32.422 V12.4.0 (2014-12) “3rd Generation Partnership Project; Technical Specification Group Services and System Aspects; Telecommunication management; Subscriber and equipment trace; Trace control and configuration management (Release 12)”, December 2014

### [Non-Patent Literature 2]

3GPP TS 37.320 V12.2.0 (2014-9) “3rd Generation Partnership Project; Technical Specification Group Radio Access Network; Universal Terrestrial Radio Access (UTRA) and Evolved Universal Terrestrial Radio Access (E-UTRA); Radio measurement collection for Minimization of Drive Tests (MDT); Overall description; Stage 2 (Release 12)”, September 2014

### [Non-Patent Literature 3]

3GPP TS36.331 V12.6.0 (2015-06) “3rd Generation Partnership Project; Technical Specification Group Radio Access Network; Evolved Universal Terrestrial Radio Access (E-UTRA); Radio Resource Control (RRC); Protocol specification (Release 12)”, June 2015

### [Non-Patent Literature 4]

3GPP TS 23.303 V12.5.0 (2015-06) “3rd Generation Partnership Project; Technical Specification Group Services and System Aspects; Proximity-based services (ProSe); Stage 2 (Release 12)”, June 2015

### [Non-Patent Literature 5]

3GPP TS 23.401 V12.9.0 (2015-06) “3rd Generation Partnership Project; Technical Specification Group Services and System Aspects; General Packet Radio Service (GPRS) enhancements for Evolved Universal Terrestrial Radio Access Network (E-UTRAN) access (Release 12)”, June 2015

### [Non-Patent Literature 6]

3GPP TS 36.413 V13.0.0 (2015-06) “3rd Generation Partnership Project; Technical Specification Group Radio Access Network; Evolved Universal Terrestrial Radio Access Network (E-UTRAN); S1 Application Protocol (S1AP) (Release 13)”, June 2015

### SUMMARY

In a network that accommodates an enormous number of IoT devices, measurement and reporting of log data by all of the IoT devices may not necessarily be required, from the MDT perspective. For example, when the network instructs a terminal to perform MDT for detecting a coverage hole, there may be a case where measurement, logging and reporting by small number of terminals are sufficient to detect such a coverage hole that occurred in a predetermined area. That is, depending on a use purpose of coverage optimization by a network side, measurement, logging and reporting by all of terminals that can detect a coverage hole may not be necessary.

The present invention has been made in view of the above issues, and an object thereof is to provide a method, an apparatus, and a non-transitory medium, each of which enables to exempt measurement, logging and reporting (making execution thereof unnecessary) of at least some of terminals among a plurality of terminals having proximity relationship to each other.

According to one aspect of the present invention, there is provided a network node comprising:

a memory; and

a processor coupled to the memory, wherein

the processor is configured to:

collect information used for determining proximity of a plurality of terminals, and

select at least one terminal from among the plurality of terminals which is caused to execute a measurement report based on the collected information.

According to another aspect of the present invention, there is provided a communication system comprising: a plurality of terminals; and a network node, wherein the network node includes at least:

a memory; and

a processor coupled to the memory, wherein

the processor is configured to:

collect information used for determining proximity of a plurality of terminals, and

select at least one terminal that executes measurement and reporting, from among the plurality of terminals, based on the collected information.

According to another aspect of the present invention, there is provided a method of controlling a network including a plurality of terminals and a network node, the method comprising:

the network node receiving at least information used for determining proximity of a plurality of terminals from another node; and

based on the information used for determining proximity of the plurality of terminals, selecting at least one terminal that executes measurement and reporting, from among the plurality of terminals.

According to another aspect of the present invention, there is provided a terminal comprising:

a transceiver configured to receive a measurement configuration, or a measurement re-configuration from a network node that operates to select at least one terminal that executes measurement and reporting, from among a plurality of terminals, based on information used for determining proximity of the plurality of terminals; and

a processor configured to perform measurement based on the received measurement configuration, or the received measurement re-configuration.

According to another aspect of the present invention, there is provided a non-transitory medium storing therein a program for causing a computer constituting a network node to execute processing comprising:

based on information received from another node, the information used for determining proximity of a plurality of terminals, selecting at least one terminal that executes measurement and reporting, from among the plurality of terminals.

According to the present invention, the non-transitory medium is a computer readable recording medium (a semiconductor memory, a magnetic recording medium, a storage such as a CD (Compact Disk)) in which the program is recorded.

According to the present invention, it is possible to exempt execution of measurement, logging and reporting (execution can be made unnecessary) on at least a part of terminals among a plurality of terminals having proximity relationship with each other. Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating a basic concept of the present invention.

FIG. 2 is a diagram illustrating a basic concept of the present invention.

FIG. 3 is a diagram illustrating one of modes of the present invention.

FIG. 4 is a diagram illustrating a first example embodiment of the present invention.

FIG. 5 is a diagram illustrating the first example embodiment of the present invention.

FIG. 6 is a diagram illustrating an operation sequence of the first example embodiment of the present invention.

FIG. 7 is a diagram illustrating a second example embodiment of the present invention.

FIG. 8A and FIG. 8B are diagrams for explaining the second example embodiment of the present invention.

FIG. 9 is a diagram illustrating an example of an operation sequence of a second example embodiment of the present invention.

FIG. 10 is a diagram illustrating another example of the operation sequence of the second example embodiment of the present invention.

FIG. 11 is a diagram illustrating LTE ProSe.

FIG. 12 is a diagram illustrating an operation sequence of a third example embodiment of the present invention.

FIG. 13 is a diagram illustrating an operational sequence of a fourth example embodiment of the present invention.

FIG. 14 is a diagram illustrating a terminal according to one embodiments of the present invention.

FIG. 15A and FIG. 15B are diagrams illustrating a measurement control unit of a processor of a terminal according to an embodiment of the present invention and a function (configuration) of a processor;

FIG. 16A is a diagram illustrating a base station according to one embodiment of the present invention.

FIG. 16B is a diagram illustrating a configuration (function) of a processor.

FIG. 17A is a diagram illustrating a network node according to one embodiment of the present invention.

FIG. 17B is a diagram illustrating the configuration (function) of the processor.

### DETAILED DESCRIPTION

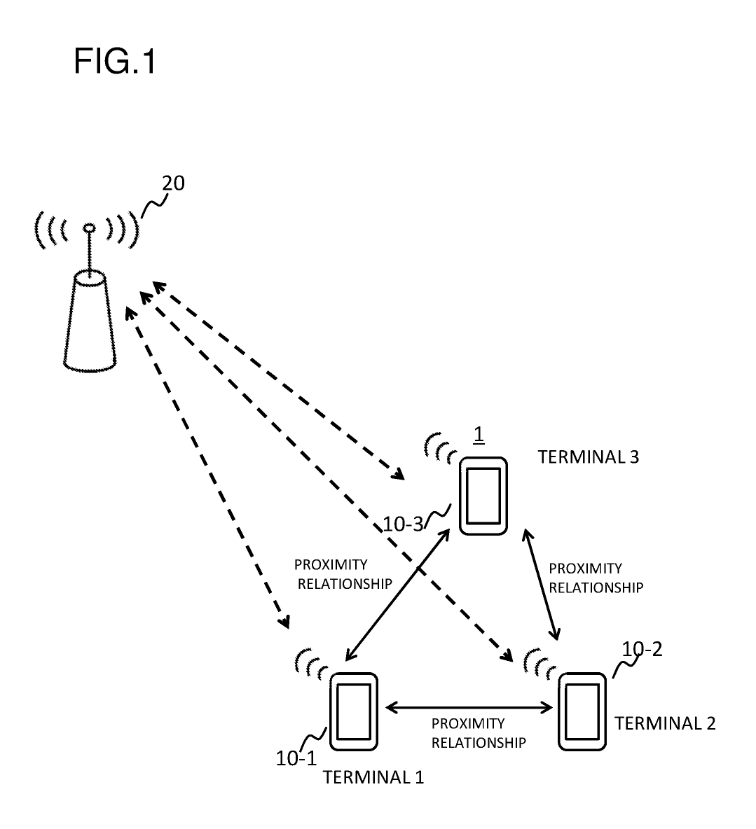

The following describes example embodiments of the present invention. FIG. 1 is a diagram illustrating a basic concept of the present invention. Referring to FIG. 1, respective terminals (for example, IoT devices) 10-1 to 10-3 are in a proximity relationship to each other (or a concomitantly moving relationship, or a relationship of being concomitantly used), and connects via a base station 20 to a core network and a packet data network (not shown). Here, the proximity relationship can be rephrased as a relationship in which a plurality of terminals satisfy a predetermined condition on proximity of the terminals to each other.

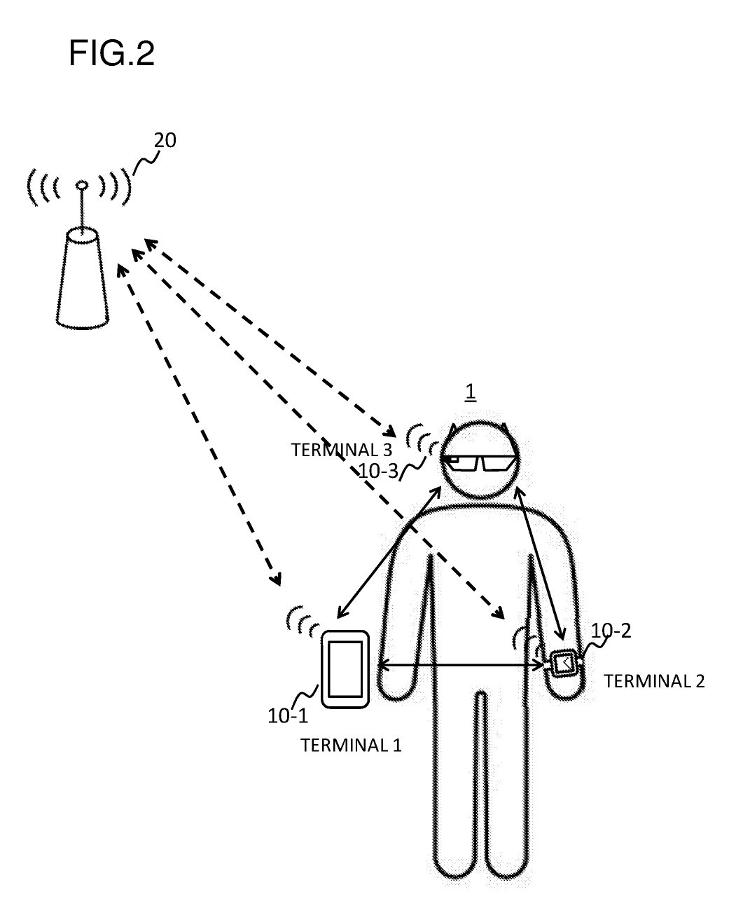

In each example embodiment, as illustrated in FIG. 2, it is assumed that examples of IoT devices include a wearable terminal such as a wrist watch, a wrist band, a ring, glasses, clothes and the like, a feature phone, a smartphone, or the like, and it is also assumed that one user wears (has) a plurality of terminals (for example, IoT devices). However, terminals to which the present invention can be applied are not limited to these examples. For example, the present invention can be applied to terminals having a proximity relationship (or a concomitantly moving relationship, or a relationship of being concomitantly used), even for a plurality of terminals with other terminals (for example, sensor nodes, drones (unmanned aerial vehicles), automobiles, and these parts (communication modules)), or a combination thereof. Since the plurality of terminals 10-1 to 10-3 in FIG. 2 are worn by the same user 1, it can be said that there is a high possibility that the terminals 10-1 to 10-3 move concomitantly.

According to the present invention, in FIG. 1, the network side collects information used for determining proximity of terminals, and based on the collected information, selects, from among the terminals 10-1 to 10-3, for example, one terminal (for example, terminal 10-2), as a representative terminal, and causes the representative terminal to execute measurement, logging and reporting, so that terminals not selected (for example, terminals 10-1, 10-3) can be exempt from measurement, logging and reporting.

Although not particularly limited, the terminals 10-1 to 10-3 have a function (D2D (Device-to-Device) communication) for performing direct communication between the terminals without going through a core network. For example, the terminals 10-1 to 10-3 may perform discovery of nearby terminals to perform direct communication (data communication, voice call, and so forth) between the nearby terminal and the terminal. The proximity of the terminals may be determined by using LTE D2D (Proximity Service: ProSe) which is specified by the 3GPP standard (e.g., Rel-12 LTE). For example, in FIG. 1, the terminal 10-1 may be configured to perform direct discovery/direct communication with the terminals 10-2 and 10-3, the terminal 10-2 may be configured to perform direct discovery/direct communication with terminals 10-1 and 10-3, and the terminal 10-3 may be configured to perform direct discovery/direct communication with terminals 10-1 and 10-2. The direct discovery may be referred to as open ProSe direct discovery.

Information used for determining proximity of a plurality of terminals is, for example, information indicating whether or not a plurality of terminals are in proximity relationship (possibility is high).

The information used for determining proximity of a plurality of terminals may be, for example, the following information, though not limited thereto.
Mobility history information of each terminal,
Information indicating execution of terminal-to-terminal direct communication of a plurality of terminals,
Subscriber information (owner information) of a plurality of terminals.

The mobility history information of each terminal is, for example, information indicating a history of movement of each terminal per predetermined time. The mobility history information may include, for example, the following information items.
Identifier (cell ID) of a cell, PLMN ID, or CSG ID, where the terminal stayed:
Time when the terminal stayed in a cell, PLMN or CSG.

The information indicating execution of the terminal-to-terminal direct communication of the plurality of terminals is information indicating that a plurality of terminals execute or have executed terminal-to-terminal direct communication. Information indicating execution of terminal-to-terminal direct communication of a plurality of terminals may include, for example, the following information.
Information on radio resources used for terminal-to-terminal direct communication,
Information (identifier) indicating a party of terminal-to-terminal direct communication,
Value of transmission power used for terminal-to-terminal direct communication,
Number of times of direct communication between terminals or communication time of the direct communication.

In FIG. 1, contractor information (owner information) of a plurality of terminals may be stored in a core network node (for example, HSS) (not shown) or the like. When the contractors (owners) of a plurality of terminals are the same, it can be assumed that there is a high possibility that the plurality of terminals are used (used together) at positions close to each other for the same user.

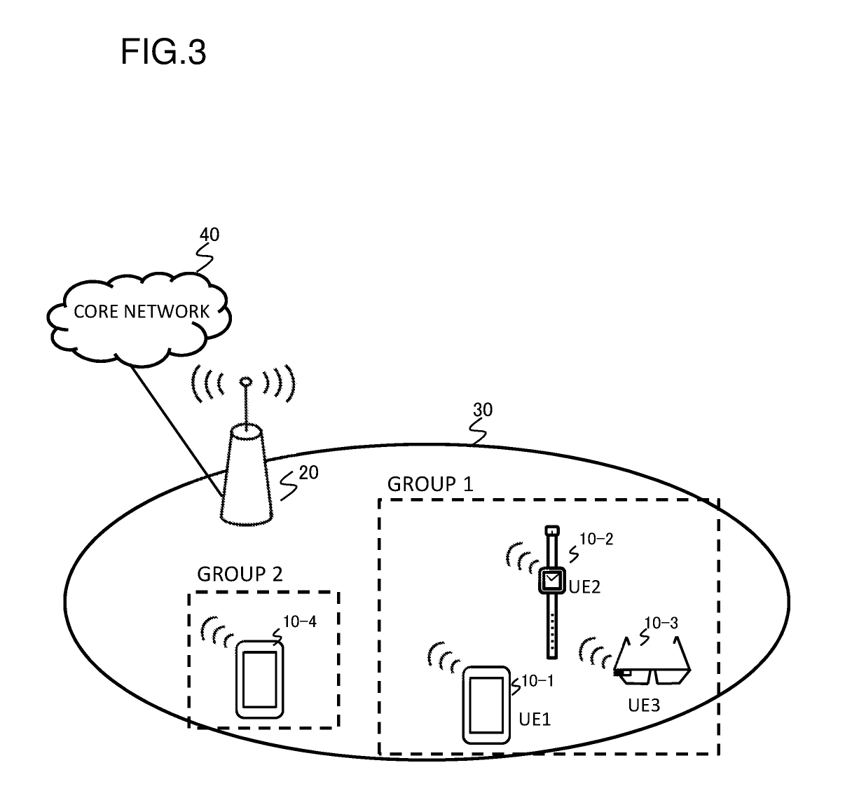

FIG. 3 is a diagram illustrating an example of a system configuration of a basic mode of the present invention. In FIG. 3, each of the terminals 10-1 to 10-3 has a proximity relationship to each other. For example, these terminals are terminals (possessed) by a user 1 in FIG. 1. A terminal 10-4 may be a terminal possessed, for example, by another user, though not limited thereto. A base station 20 of a radio access network 30 is connected to a core network 40. The core network 40 may be, for example, an Evolved Packet Core (EPC). The core network 40 may be a core network of MVNO (Mobile Virtual Network Operator) or a virtual core network.

In a network side (a management node (not shown) in the core network 40), a plurality of terminals 10-1 to 10-3 may be managed by grouping the plurality of terminals 10-1 to 10-3. In that case, among the terminals belonging to the same group, for example, one terminal (for example, 10-2) may be caused to execute measurement and reporting.

The following describes, as an example, group management of terminals. In the example of FIG. 3, a management node of the core network 40 manages the terminals 10-1 to 10-3 that the user 1 wears (has), as a group 1. In the example of FIG. 3, another terminal 10-4 belongs to a group 2 which is a different group. In FIG. 3, for simplicity of drawing creation, four terminals are shown. As exemplified in FIG. 3, terminals are managed by the grouping, as a result of which a request from the network side (i.e. making a measurement report at a position of the terminal) is satisfied, while a load on the terminal side can be reduced. For example, in the group 1, only the terminal 10-2 executes MDT measurement, logging and reporting, while the terminals 10-1 and 10-3 do not execute MDT measurement, logging and reporting. For this reason, the load on the terminals 10-1 and 10-3 is reduced. When a plurality of terminals are grouped, the number of representative terminals is not limited to one, and according to redundancy of measurement, logging and reporting and a purpose of measurement, logging and reporting (for example, detection of a coverage hole) and the like, from among a plurality of terminals (N terminals, where N is a positive integer of 2 or more), one or more terminals, N−1 at maximum (for example, 2) may be selected and caused to execute measurement. In the present invention, a management of a plurality of terminals is not limited to grouping management.

According to the present invention, there is provided a network node that receives, from another node, information used for determining proximity of a plurality of terminals. And then, the network node selects at least one terminal that executes measurement and reporting, based on the information used for determining proximity of the plurality of terminals. The network node may be a base station, a predetermined node connected to a core network, a server, or the like. In the below, some example embodiments will be described with reference to the drawings.

### First Example Embodiment

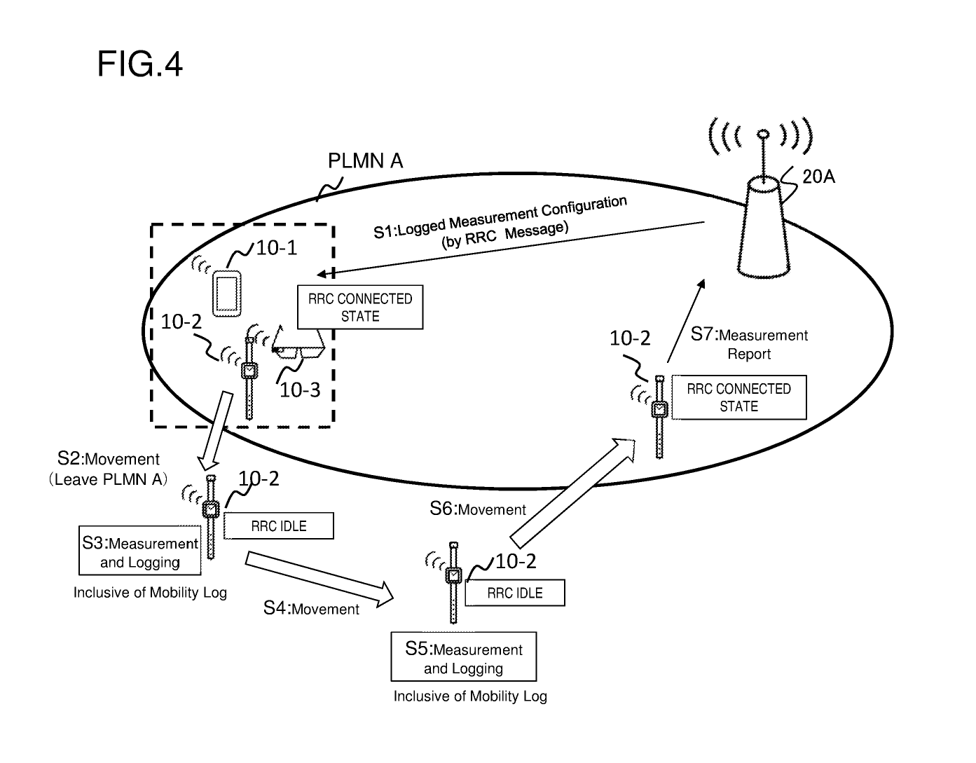

FIG. 4 is a diagram illustrating a first example embodiment of the present invention. In FIG. 4, an example in which the present invention is applied to a logged MDT is illustrated. In FIG. 4, S1, S2, or the like, each represents an order (step) of a sequence operation (process) in the drawing. In addition, the terminals 10-1 to 10-3 in FIG. 4 can connect to a mobile network A (PLMN A) (to which the terminal is permitted to be served, or with which the terminal can establish a radio link). The base station 20A of the mobile network A (PLMN A) transmits logged measurement configuration information to the terminal in an RRC connected state, using, for example, an RRC message (S1). When the terminal makes a transition to an RRC idle state, the terminal is caused to execute measurement and logging. In this example, it is assumed that the terminal 10-2 executes measurement and logging as a representative of the terminals 10-1 to 10-3. When the terminals 10-1 to 10-3 leave the PLMN A, a radio quality, or the like, in a radio link with the PLMN A deteriorates and respective radio links of the terminals with the PLMN A are disconnected (Radio Link Failure) (for example, an RRC connection is disconnected). And then, the terminals each transition to an RRC idle state (S2).

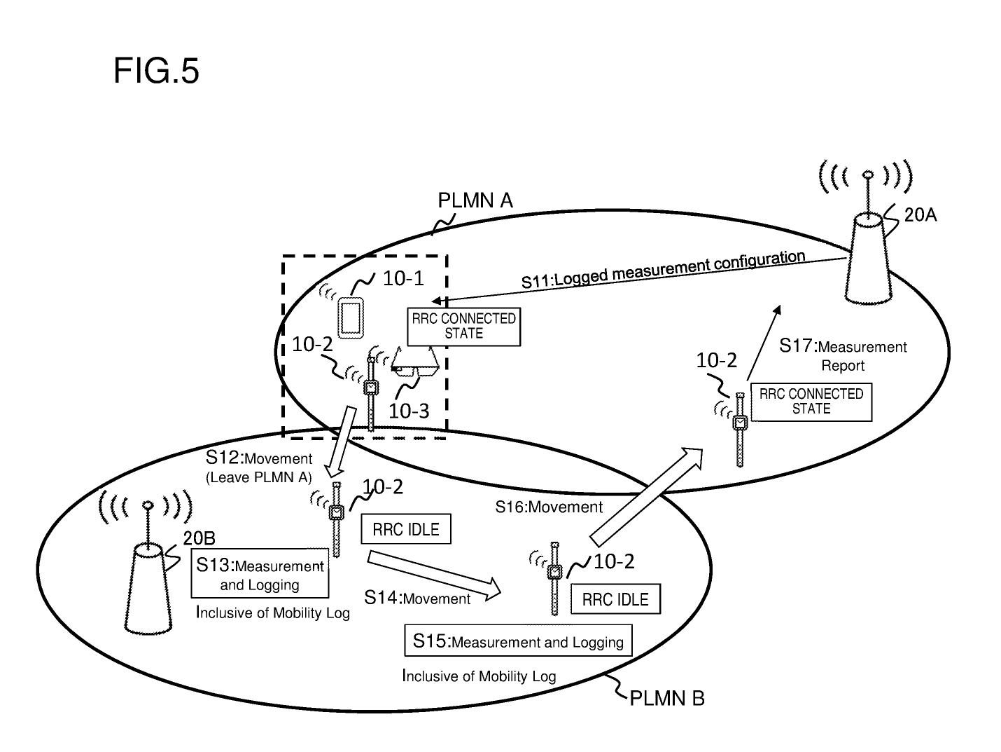

The terminal 10-2 in an RRC idle state executes measurement and logging based on the logged measurement configuration information (S3). In a case where the terminal 10-2 logs a measurement result, the terminal 10-2 may record mobility history information of the terminal 10-2. It is noted that the mobility history information may include a staying time of the terminal in a cell in which measurement and logging are performed, and Cell ID. For example, as illustrated in FIG. 5, in a case where a location of the terminal 10-2, at which the terminal 10-2, after leaving the PLMN A, makes a transition to an RRC idle state, is within a cell of a mobile network B (PLMN B), the terminal 10-2 may execute measurement and logging of a cell ID of the PLMN B (and/or a PLMN ID of the PLMN B) and a staying time in a cell of the PLMN B. It is noted that the mobile network B (PLMN B) is assumed to be such a PLMN, to which the terminals 10-1 to 10-3 are not equipped with function of connecting (or establishing a radio link connection), to which the terminals 10-1 to 10-3 are not allowed to belong, or to which the terminals 10-1 to 10-3 are not allowed to belong, but allowed to connect (or establishment of a radio link). Furthermore, even in this case, it is assumed that the terminals 10-1 to 10-3 can receive signals for identifying a cell ID and the like of the PLMN B.

Further, a group of the terminals 10-1 to 10-3 move outside an area of the PLMN A in an RRC idle state (S4). It is noted that a moving range may be within a cell of PLMN B as illustrated in FIG. 5. For convenience of drawing creation, only the terminal 10-2 is shown outside an area of PLMN A in FIG. 4 and within an area of PLMN B in FIG. 5, and the terminals 10-1 and 10-3 are omitted.

Further, the terminal 10-2 in an RRC idle state executes measurement and logging (S5) at a movement destination (S4). In a case where the terminal 10-2 logs a measurement result, the terminal 10-2 may record mobility history information of the terminal 10-2, as in step S3.

The terminals 10-1 to 10-3 move (re-belong or re-connect) to a cell of PMLN A (S6). The terminal 10-2 that has transitioned to an RRC connected state transmits a measurement report to the base station 20 (S7). The base station 20 may transmit a measurement report received from the terminal 10-2 to a management server, such as TCE (Trace Collection Entity) not shown, OAM (Operations, Administration, Maintenance), or the like, for example.

In addition, in FIG. 4, for the sake of simplicity of explanation, the terminal 10-2 executes measurement and logging in an RRC idle state, outside the cell of the PLMN A (outside an area), but not limited to this case. For example, the terminal 10-2 may execute measurement and logging when the terminal 10-2 makes a transition to an RRC idle state within a cell of the PLMN A. The transition of the terminal 10-2 to an RRC idle state within the cell of PLMN A may occur due to a coverage hole occurred in the cell of PLMN A. Even when the terminal 10-2 makes a transition to an RRC idle state within the cell of the PLMN A, the terminal 10-2 may execute measurement and logging, if the terminal can measure information on the PLMN B, as illustrated in FIG. 5 (for example, a cell ID or a PLMN ID of PLMN B, or a staying time in PLMN B or the cell).

It is noted that the cell of the mobile network B (PLMN B) in FIG. 5 may be replaced with a cell of CSG to which the terminal is not permitted to belong. That is, after the terminal 10-2 leaves the PLMN A and makes a transition to an RRC idle state, the terminal 10-2 may execute measurement and logging of a cell ID of CSG (and/or the CSG ID of CSG), and a staying time in the CSG cell.

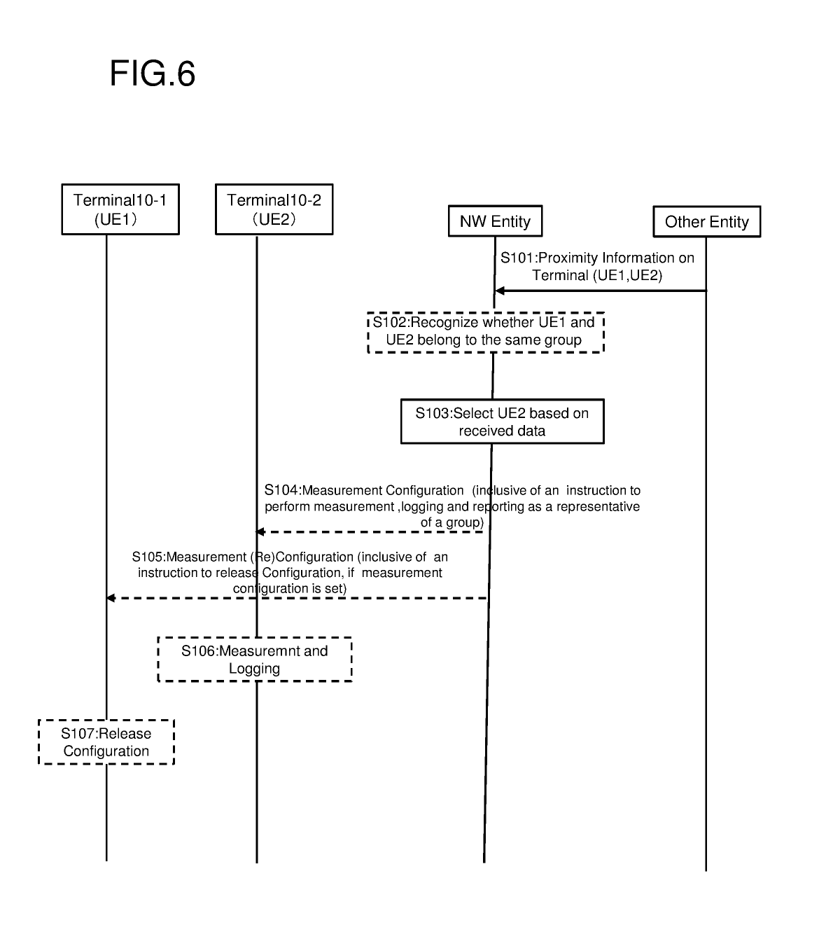

FIG. 6 is a diagram illustrating an operation sequence of the first example embodiment of the present invention. In FIG. 6, two terminals are shown only for the convenience of drawing creation. In FIG. 6, a network entity (NW entity) may be a base station (eNB) of LTE (Long Term Evolution), a base station (Node B) of UMTS, an RNC, MME (Mobility Management Entity), HSS (Home Subscriber Server), TCE, ProSe function (ProSe (Proximity-based Services) Function), SUPL (Secure. User Plane Location) node, or the like, of an Evolved Packet Core (EPC) 40. A network entity may be also referred to as a network node. The MME performs mobility management of a terminal, authentication (security control), and configuration processing of a path transferring a user data. The MME performs mobility management and authentication of the terminal in cooperation with the HSS.

In FIG. 6, an other entity may be the terminal 10-1 (UE1), the terminal 10-2 (UE2) or a network entity (for example, eNB, Node B, RNC, MME, or HSS). Alternatively, the other entity may be a ProSe function (ProSe (Proximity-based Services) Function) or a SUPL (Secure.User Plane Location) node. ProSe is a terminal-to-terminal direct communication function, which is specified in Non-Patent Document 4 (3 GPP TS 23.303) and the like. SUPL is a location information service standard defined by Open Mobile Alliance (OMA). A SUPL node (server), by using a user plane (IP (Internet Protocol) packet), transmits and receives location information and assist data with a terminal (e.g. a terminal that supports the SUPL). In the sequence illustrated in FIG. 6, S101, S102, . . . , each of which is attached to an arrow, a box, or the like, indicate a sequence number (step number) in the drawing. A dashed line arrow and a broken line box may be used as options.

The other entity provides to the NW entity information used for determining proximity between the terminal 10-1 and the terminal 10-2 (UE1, UE2) (S101).

Based on the received information used for determining the proximity, the NW entity determines that the terminal 10-1 and the terminal 10-2 (UE1, UE2) belong to the same group (S102).

Based on the information used for determining proximity, the NW entity selects at least one terminal (terminal 10-2) among the terminals 10-1 and 10-2 (UE1, UE2) (S103). The selected terminal may be a terminal that executes measurement, logging and reporting, or may be a terminal for which execution of measurement, logging and reporting are exempted.

The NW entity instructs to configure the measurement (Measurement Configuration) to the terminal 10-2 (UE2) in an RRC connected state (S 104). It is noted that this Measurement Configuration may include an instruction to execute measurement, logging, and reporting as a representative of the group, and a terminal ID as a target of the instruction.

It is noted that the NW entity instructs reconfiguration of the logged measurement (Measurement (Re) Configuration) to the terminal 10-1 (UE1) (S105). The measurement reconfiguration may include information indicating exemption from execution of measurement, logging and reporting (execution not required). In a case where the measurement configuration has already been configured in the terminal 10-1, the exemption from execution of the measurement may be performed by an instruction to release the configuration is set in a logged measurement reconfiguration.

The terminal 10-2 (UE2) executes measurement and logging, for example, in an RRC idle state (S106).

The terminal 10-1 (UE1) releases the measurement configuration (in a case where the measurement configuration has already been made) (S107).

In one embodiment of the present invention, a NW entity selects at least one terminal that executes (or is exempted from) measurement, logging and/or reporting, based on the information used for determining proximity between a plurality of terminals, the information being received from the other entity. It is noted that the NW entity may recognize (consider) that the plurality of terminals belong to the same group based on the proximity information of the plurality of terminals (10-1, 10-2). Measurement, logging and/or reporting may comply with MDT. Alternatively, a measurement report other than MDT may be adopted.

Although not limited thereto, an object of measurement, logging and/or reporting is, for example,
Radio quality of a camping cell;
Camping cell ID (Identity);
Time stamp (e.g. absolute time stamp (absolute time) or relative time stamp (relative date and time));
Location information (e.g. detailed location information);
Neighbour cell ID;
Mobility history information, or the like.

### Second Example Embodiment

A basic arrangement of the system according to the second example embodiment of the present invention is the same as the arrangement shown in FIG. 3 and so forth. In the second example embodiment of the present invention, at least one terminal that executes measurement and reporting is selected, based on mobility history information of a plurality of terminals. For example, based on the mobility history information received from a plurality of terminals, one terminal that executes a logged MDT is selected from among the plurality of terminals.

In the second example embodiment, when the base station 20 transmits logged measurement configuration to the terminal 10, the base station 20 may not yet recognize which terminal 10 has a proximity relationship with each other. Therefore, the base station 20, according to the present embodiment, at first, transmits logged measurement configuration to all target terminals 10-1 to 10-3. It is noted that the target terminal is such a terminal which has, for example, capability (UE capability) of executing measurement and logging compliant with MDT, a user of which has a consent for MDT (User consent), and which is located within a target tracking area TA.

In the second example embodiment, reports on measurement and logging transmitted from the terminals 10-1 to 10-3 to the base station 20 are included in a terminal information response (UE information response), in response to reception of a terminal information request (UE information request). And then the measurement log is reported to the base station.

Based on the mobility history information received from the terminal, the base station 20 (eNB/RNC) selects at least one terminal that executes MDT, among a plurality of terminals relating to mobility during a predetermined period, from among a plurality of terminals within an MDT target tracking area (or routing area).

More specifically, the eNB/RNC determines that a plurality of terminals have relationship of mobility within a predetermined period (i.e. the plurality of terminals belongs to the same group) based on the mobility history information received from the terminal, and selects one terminal that executes (is exempted from) measurement, logging and reporting (MDT) from among the plurality of terminals in following cases:
in a case where cell IDs in which it stays in a predetermined period are the same or within a predetermined range, and
in a case where a staying time for each cell is the same or within a predetermined range.

Then, the base station/control station (eNB/RNC) executes the following (a) and/or (b).

(a) Transmits, to a terminal is caused to execute MDT, (re) configuration information instructing measurement, logging and reporting, as a representative terminal.

(b) Transmits, to a terminal that does not need MDT execution (exempted from MDT execution), (re) configuration information including information indicating discard or release of the measurement configuration information. Upon reception of the (re) configuration information, the terminal discards or releases of the configured measurement configuration information, in a case where measurement configuration information has been already configured.

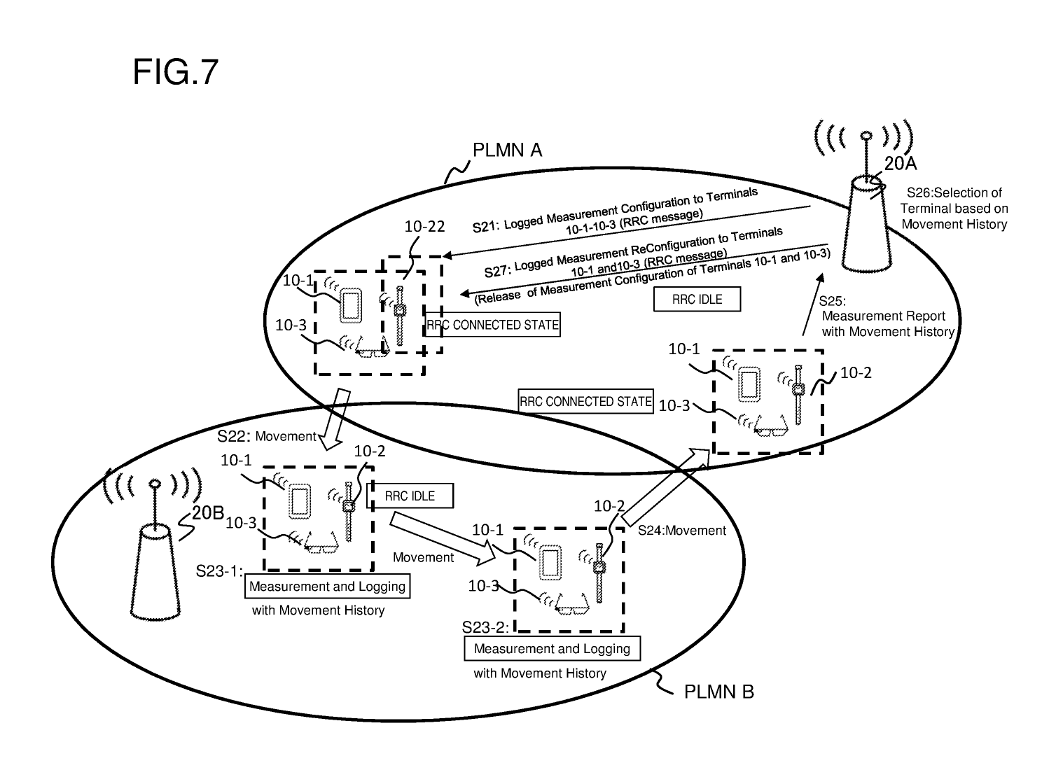

FIG. 7 is a diagram illustrating a second example embodiment. As in FIG. 4, it is assumed that the terminals 10-1 to 10-3 in FIG. 7 can connect to the mobile network A (PLMN A) (or, is permitted to belong thereto or can establish a radio link therewith), but the terminals 10-1 to 10-3 are not equipped with function of connecting (or establishing a radio link) with the mobile network B (PLMN B), the terminals 10-1 to 10-3 are not allowed to belong to the mobile network B (PLMN B), or the terminals 10-1 to 10-3 are allowed to belong but not allowed to connect (or establish a radio link) with the mobile network B (PLMN B). Furthermore, even in this case, it is assumed that the terminals 10-1 to 10-3 can receive signals for identifying a cell ID or the like of the PLMN B. The base station 20A of (a cell of) the mobile network A (PLMN A) transmits logged measurement configuration information, using an RRC message, to the terminals 10-1 to 10-3 in an RRC connected state (S21).

The terminals 10-1 to 10-3 (UE1 to UE3) move to a cell of the base station 20B of (a cell of) the mobile network B. With the movement along a direction of the cell of PRMN B, a radio quality or the like in a radio link with the PLMN A deteriorates, the radio link with the PLMN A is disconnected (i.e. Radio Link Failure) (for example, RRC connection is disconnected), and makes a transition to an RRC idle state (S22). Each of the terminals 10-1 to 10-3 (UE1 to UE3) in an RRC idle state executes measurement and logging (measurement and log) including an item (objects) of mobility history information (S23-1). Further, the terminals 10-1 to 10-3 (UE1 to UE3) move to another place in the cell of the base station 20 B of the PLMN B and the terminals 10-1 to 10-3 (UE1 to UE3) in an RRC idle state executes measurement and logging (measurement and log) including an item (objects) of mobility history information (S23-2).

The terminals 10-1 to 10-3 (UE1 to UE3) move (re-belong or re-connect) to the cell of the base station 20A of the PMLN A (S24).

After the terminals 10-1 to 10-3 (UE1 to UE3) each make a transition to an RRC connection state, the terminals 10-1 to 10-3 (UE1 to UE3) transmit the measurement reports including the mobility history information to the base station 20A (S25).

Based on the mobility history information from the terminals 10-1 to 10-3, the base station 20A selects a terminal that executes the logged MDT as a representative terminal (S26). More specifically, if the mobility history information of the terminals 10-1 to 10-3 satisfies a predetermined condition regarding proximity, the base station 20A selects, among the terminals 10-1 to 10-3, the terminal 10-2, for example.

Here, a predetermined condition regarding proximity includes at least one of:
that histories of cells (cell IDs or the like) or PLMNs (PLMN IDs or the like) where each terminal stayed, are the same or within a predetermined range, and
that at least part of staying periods (or their error range) in the cells or PLMNs which each terminal stays overlaps with each other (the same or within in a predetermined range).

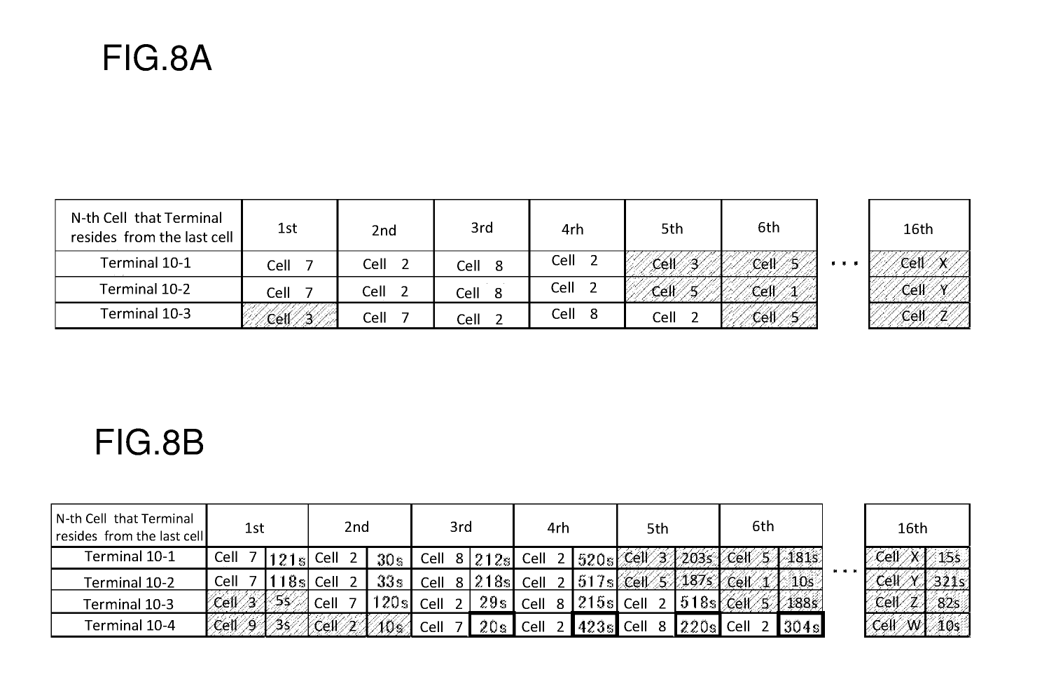

The following describes a specific example in the case where the mobility history information of the terminals 10-1 to 10-3 satisfies a predetermined condition on the proximity with reference to FIG. 8A and FIG. 8 B.

FIG. 8 A is a table illustrating a history of cells in which each of the terminals 10-1 to 10-3 stayed to Nth (N is an integer of 1 or more) from the last. Here, “cell (number)” indicates a cell ID. For example, the cells in which the terminal 10-1 has stayed to the Nth from the last, are cell 7, cell 2, cell 8, cell 2, cell 3, cell 5, . . . , and cell X (X is an integer of 1 or more) (likewise, Y and Z are integers of 1 or more). Here, the cell IDs of the cells in which the terminal 10-1 and the terminal 10-2 stayed from the first to the fourth and the cell IDs of the cells in which the terminal 10-3 stayed from the second to the fifth from the last are both cell 7, cell 2, cell 8, and cell 2 in this order, and they match.

Therefore, since the history of the cells (cell ID, or the like) in which the terminals 10-1 to 10-3 stayed are the same within a predetermined range, the base station 20A selects one among the terminals 10-1 to 10-3. For example, the base station 20A selects the terminal 10-2.

Further, FIG. 8B is a table illustrating cells in which each of the terminals 10-1 to 10-3 and the terminal 10-4 stayed to the Nth cell (N is an integer of 1 or more) from the last and the staying time (seconds: s). In FIG. 8 B, for example, the staying time in each cell that the terminal 10-1 has stayed to the Nth cells from the last, are 121 s (second) in cell 7, 30 s in cell 2, 212 s in cell 8, 520 s in cell 2, 203 s in cell 3, 181 s in cell 5, . . . , and 15 s in cell X.

Here, IDs of the cells in which the terminals 10-1 and 10-2 have stayed from the first to the fourth from the last, IDs of the cells in which the terminal 10-3 has stayed from the second to the fifth from the last, and IDs of the cells in which the terminal 10-4 has stayed from the third to the sixth from the last, are, cell 7, cell 2, cell 8, and cell 2 in this order and they match. However, an error range of the staying time in each cell is within 10 s in each of the terminals 10-1 to 10-3, whereas an error range of the staying time is 10 s or more between the terminal 10-4 and each of the terminals 10-1 to 10-3.

Therefore, the base station 20A selects the terminal 10-2 from among the terminals 10-1 to 10-3, because the history of the cells (cell ID, or the like) in which the terminals 10-1 to 10-3 have stayed are the same within a predetermined range and that the error range of the staying time of each terminal in the cell is within a predetermined range.

The base station 20A transmits, if necessary, logged measurement reconfiguration information, using an RRC message, to the terminal 10-2 that causes the terminal 10-2 to execute logged MDT (as a representative) (S7). Here, the logged measurement reconfiguration information transmitted to the terminal 10-2 may include information indicating that the terminal 10-2 executes MDT as a representative. In addition, the base station 20A transmits logged measurement reconfiguration information to the terminals 10-1 and 10-3 exempted from execution of the logged MDT, as necessary, using an RRC Message (S7). Here, the logged measurement reconfiguration information transmitted to the terminals 10-1 and 10-3 may include information indicating discard or release of the measurement configuration information. The terminals 10-1 and 10-3 that receive the measurement configuration information may discard or release the measurement configuration information that has been already configured therein. Thereafter, only the terminal 10-2 among the terminals 10-1 to 10-3 executes measurement, logging and reporting.

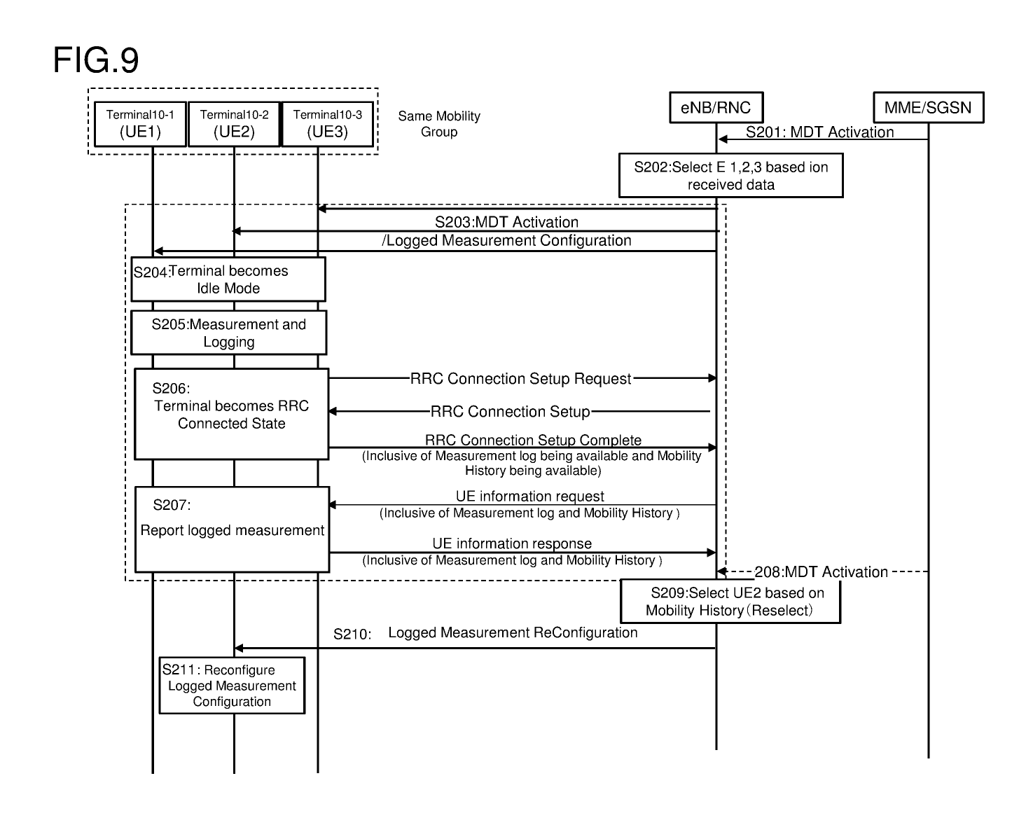

FIG. 9 is a diagram illustrating an operation sequence of the second example embodiment. In FIG. 9, a base station eNB of the LTE is connected to an MME of a core network (EPC) (40 of FIG. 4) via an S1-MME interface. A radio network controller RNC of the UTRAN is connected to an SGSN of the core network (EPC) via an Iu interface. Note that SGSN (Serving GPRS (General Packet Radio Service) Support Node) is connected to the MME via an S3 interface and connected to a SGW (Serving-GateWay) via an S4 interface. As with the MME, the SGSN is also connected to an HSS. An eNB corresponds to the base station 20A in FIG. 7.

MDT activation information is transmitted from the MME or SGSN to the eNB/RNC (S201).

The eNB/RNC selects the terminals 10-1 to 10-3 (UE1, UE2, UE3) based on the received data (S202).

The eNB/RNC transmits logged measurement configuration information to the terminals 10-1 to 10-3 (S203). The transmission of the logged measurement configuration information here may implicitly indicate an instruction of MDT activation.

The terminals 10-1 to 10-3 enter an RRC idle state (S204).

The terminals 10-1 to 10-3 execute measurement and logging based on the logged measurement configuration information (S205).

The terminals 10-1 to 10-3 enter an RRC connected state (S206). For example, in the step S206, the terminals 10-1 to 10-3 transmit an RRC Connection Setup Request to the eNB/RNC for establishing an RRC connection with the eNB/RNC. And then, the eNB/RNC responses RRC Connection Setup to the terminals 10-1 to 10-3. The terminals 10-1 to 10-3 transmit an RRC Connection Setup Complete to the eNB/RNC, in response to reception of the RRC Connection Setup. In a case where, the terminals 10-1 to 10-3 each store or have measurement data, the terminals 10-1 to 10-3 each set, into the RRC Connection Setup Complete, information indicating that the recorded measurement data can be provided. When the terminals 10-1 to 10-3 each store and have mobility history information, the terminals 10-1 to 10-3 each set, into the RRC Connection Setup Complete, information indicating that the mobility history information can be provided.

The eNB/RNC transmits a terminal information request (UE Information request) to the terminals 10-1 to 10-3. The terminal information request (UE Information request) is a message used by a network (E-/UTRAN) side for requesting terminal information to the terminal. The terminal information request may include a request for measured/logged data and a request for mobility history information.

The terminals 10-1 to 10-3 transmit a terminal information response (UE Information Response) to the eNB/RNC (S207). In a case where the terminal information request received by each of the terminals 10-1 to 10-3 includes a request for measurement data and a request for mobility history information, the terminals 10-1 to 10-3 each set, into the terminal information response, corresponding measurement, logging (measurement data), and mobility history information.

MDT activation information is again transmitted from the MME/SGSN to the eNB/RNC (S208).

The eNB/RNC selects the terminal 10-2 (UE2) from among the terminals 10-1 to 10-3 (UE1, UE2, and UE3) based on the mobility history information, for example (S209).

The eNB/RNC transmits logged measurement reconfiguration to the terminal 10-2 (UE2) (S210).

The terminal 10-2 (UE2) which has received the logged measurement reconfiguration information performs logged measurement reconfiguration (S211). As a result, the terminal 10-2 (UE2) performs MDT measurement and reporting. The terminals 10-1 and 10-3 that do not receive logged measurement reconfiguration information (Logged Measurement Reconfiguration) need not perform MDT measurement/reporting. Although not shown in FIG. 7, the base station 20 (eNB/RNC) that has received the measurement, logging report from the terminals 10-1 to 10-3 may store the measurement log into a trace record and may report the measurement log to a network node (for example, TCE (Trace Collection Entity)). In that case, the measurement log data of the terminal 10-2 that has performed measurement, logging and reporting (MDT) as a representative of the terminals 10-1 to 10-3 may have information (for example, a flag, an identifier) added to distinguish from other measurement, and may be reported from the base station 20 to the network node (for example, TCE (Trace Collection Entity)). The information used to distinguish from other measurement, logging may be information indicating that it represents, for example, measurement, logging and report (MDT).

Timings of transition to an RRC idle state or an RRC connected state of the terminals 10-1 to 10-3 are not necessarily simultaneous.

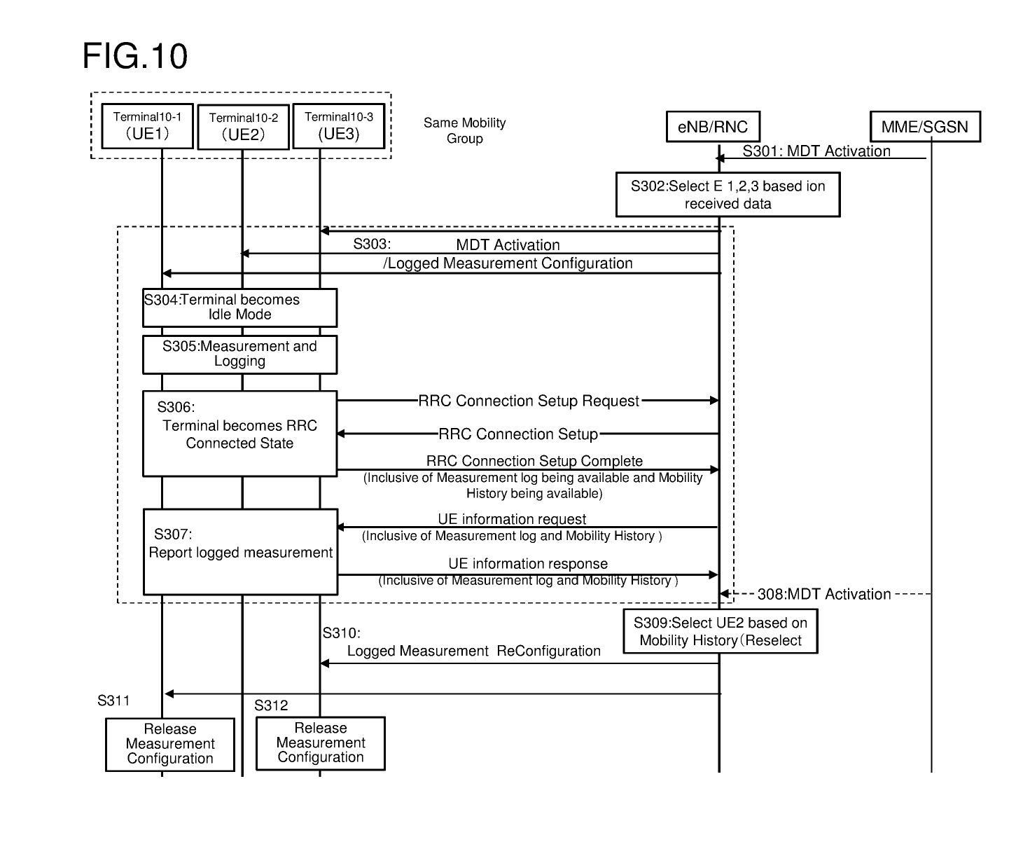

FIG. 10 is a diagram illustrating an operation of the second example embodiment described with reference to FIG. 7. In FIG. 10, steps S301 to S309 are the same as steps S201 to S209 of FIG. 9, respectively. In S310 of FIG. 10, logged measurement reconfiguration information is instructed to the terminals 10-1 and 10-3. This corresponds to S27 in FIG. 7. The logged measurement reconfiguration information here includes information indicating discard or release of the measurement configuration information.

The terminal 10-1 and the terminal 10-3 discard or release measurement log respectively has been already configured therein, if information indicating discard or release of the measurement configuration information is included in the received logged measurement re-configuration information (S311, S312). As a result, the terminal 10-1 and the terminal 10-3 do not perform MDT measurement and reporting.

As described above, according to the present embodiment, the network determines that a plurality of terminals are in close proximity to each other from mobility history information of a plurality of terminals, and selects a terminal that executes (or is exempted from) measurement, logging and reporting (MDT). As a result, it is possible to avoid measurement reports from all of the plurality of terminals that are located substantially at the same location, or are concomitantly moving (possibly high), and to prevent reporting of information duplicate at least in part, to the network, thereby enabling to contribute to reduction of wasteful processing and power consumption in the terminal.

### Third Example Embodiment

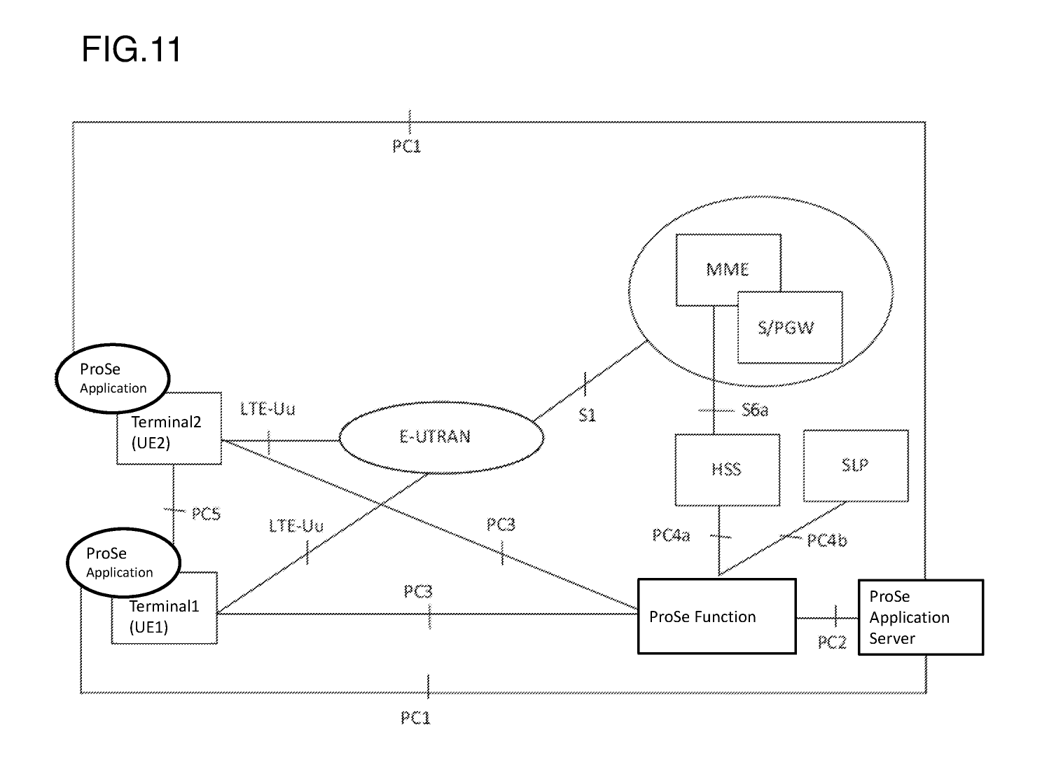

A basic arrangement of a system according to the third example embodiment of the present invention is the same as the configuration as illustrated in FIG. 3. In the third example embodiment of the present invention, based on direct communication between terminals, at least one terminal which is caused to execute a measurement report, may be selected. A ProSe function and a ProSe application server are connected to a mobile network A (PLMN A) 30. FIG. 11 is a diagram illustrating LTE Prose. Note that FIG. 11 is a diagram cited from the standard specification of ProSe of 3 GPP (FIGS. 4.2—1 of Non-Patent Document 4 (3 GPP TS 23.303 V 12.5.0 Release 12)). In FIG. 11, a terminal 1 and a terminal 2 perform D2D communication. The ProSe function is a network node that performs operations necessary for ProSe. The ProSe application server stores an EPC (Evolved Packet Core) ProSe user ID and the ProSe function ID, and performs mapping between the EPC ProSe user ID and a user ID in an application layer. The ProSe function is connected to each terminal via a PC 3 interface. The ProSe function is connected to HSS and SLP (Secure User Plane Location (SUPL) Location Platform) via interfaces of PC4a and PC4b, respectively.

In the present embodiment, at least one terminal which is caused to execute a logged MDT may be selected based on ProSe discovery, that is, ProSe EPC-level Discovery/ProSe Direct Discovery.

Regarding ProSe discovery, the EPC level discovery (ProSe EPC-level discovery) is a method in which a network (for example, core network (EPC)) detects proximity of two terminals (ProSe enabled UEs) and notifies the terminal of the proximity. In the direct discovery (ProSe Direct Discovery), a terminal (ProSe-enabled UE) discovers another terminal (ProSe-enabled UE) in a neighbour location, for example due to capability of the terminal. The terminal (ProSe-enabled UE) has a function of exchanging ProSe control information between the terminal (ProSe-enabled UE) and a ProSe function node, and a function of ProSe Direct Discovery of another terminal (ProSe-enabled UE).

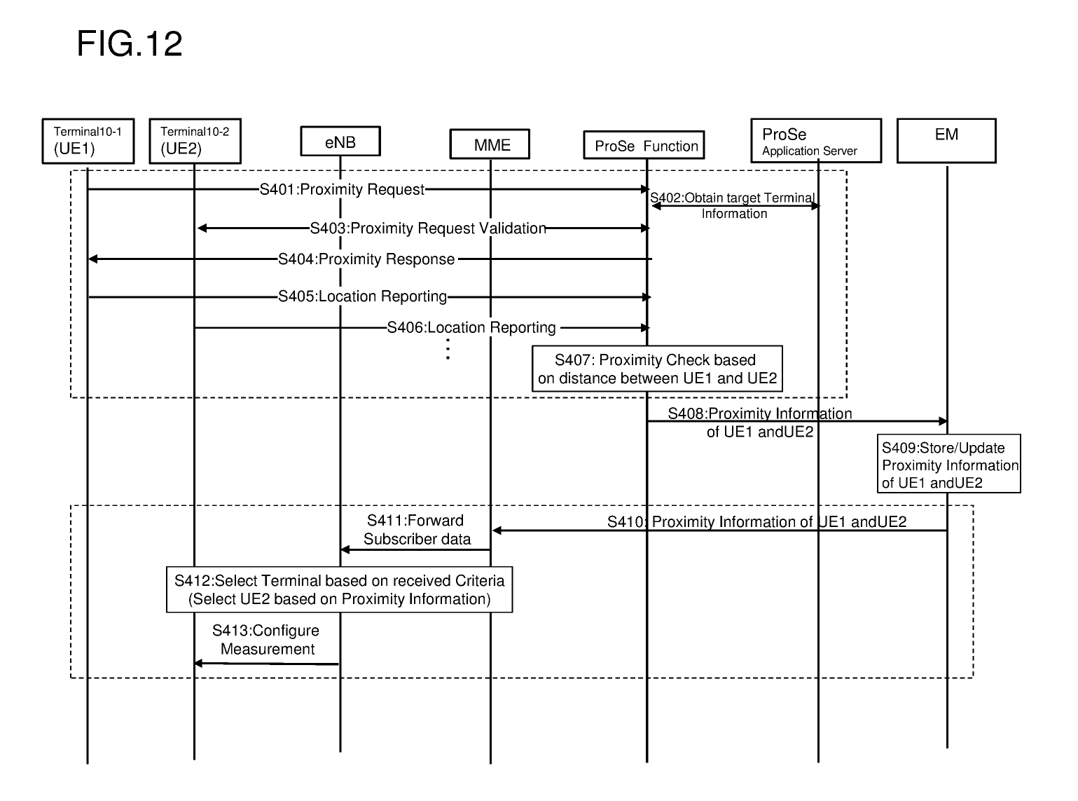

FIG. 12 is a diagram illustrating an operation of the third example embodiment and illustrates sequences in a case where ProSe EPC level discovery is applied to the present invention. S401, S402, . . . attached to arrows, boxes, and the like in FIG. 12 represent sequence numbers in the drawing. In FIG. 12, EM (Element Manager) is a node that stores Proximity Information for each terminal and is made up of an HSS or the like in FIG. 11, for example. In FIG. 12, an MME, a ProSe function, and a ProSe application server correspond to those shown in FIG. 11, respectively.

The terminal 10-1 (UE1) transmits a Proximity Request to the ProSe function (S401). The proximity request may include terminal information of the terminal 10-1 (UE1) and terminal information of the target terminal (terminal 10-2 (UE2 in FIG. 10)).

The terminal information of the target terminal (Target UE Info) is acquired between the ProSe function and the ProSe application server (S402).

The ProSe function performs verification of the proximity request (Proximity Request Validation) between the ProSe function and the terminal 10-2 (UE2) (S403).

After the proximity request verification has been completed, the ProSe function transmits a proximity response to the terminal 10-1 (UE1) (S 404).

The terminal 10-1 (UE1) transmits a location reporting to the ProSe function via a SLP (SUPL Location Platform) (S405).

The terminal 10-2 (UE2) also transmits a location reporting to the ProSe function via the SLP (SUPL Location Platform) (S406).

The ProSe function executes a proximity check based on a distance between the terminals 10-1 and 10-2 (UE1, UE2) (S407).

The ProSe function notifies the EM of proximity information between the terminals 10-1 and 10-2 (UE1, UE2) (S408).

The EM stores/updates the proximity information between the terminals 10-1 and 10-2 (UE1, UE2) (S409).

Thereafter, if it is decided to cause the terminal 10 to execute the MDT, the EM transmits the proximity information between the terminals 10-1 and 10-2 (UE1, UE2) to the MME (S 410). In a case where the EM is an HSS, the proximity information may be transmitted in “Insert Subscriber Data procedure” between the HSS and the MME (Non-Patent Document 5 (3GPP TS 23. 401)).

The MME stores the proximity information and transfers the proximity information to an eNB (S411). Here, the proximity information may be transmitted in “INITIAL CONTEXT SETUP REQUEST” (Non-Patent Document 6 (3 GPP TS 36.413)) performed by “Context Management procedures” between the MME and the eNB. More specifically, the MME may set proximity information into a “ProSe Authorized IE” or a “Management Based MDT Allowed IE” included in “INITIAL CONTEXT SETUP REQUEST” for transmission or may set a new information element indicating the proximity information into “INITIAL CONTEXT SETUP REQUEST” for transmission.

The eNB selects a terminal based on the received information or criteria. In this case, the terminal 10-2 (UE2) is selected based on the proximity information between the terminals 10-1 and 10-2 included in the received information or criteria (S412).

The eNB transmits measurement configuration information (Measurement Configuration) to the terminal 10-2 (UE2) (S413). It is noted that transmission of the measurement configuration (Logged Measurement Configuration) information here may indicate implicitly an MDT activation instruction.

The node EM that stores proximity information need not be an HSS, but may be any core network node.

Further, contractor information of a plurality of terminals may be transmitted from the HSS and the contractor information may also be used to select a terminal that performs a logged MDT. The contractor information may be included in a “ProSe Authorized IE” or a “Management Based MDT Allowed IE” transmitted between the MME and the base station (eNB). The details of the contractor information will be described later. Radio resource allocation performed from the base station 20 to the terminals 10-1 and 10-2 is performed by broadcast information (SIB) and an RRC signaling. In the present embodiment, RRC signaling is used.

In FIG. 12, Location Reporting in step S405 may be once collected in the SLP (SUPL Location Platform) and then stored in the ProSe function.

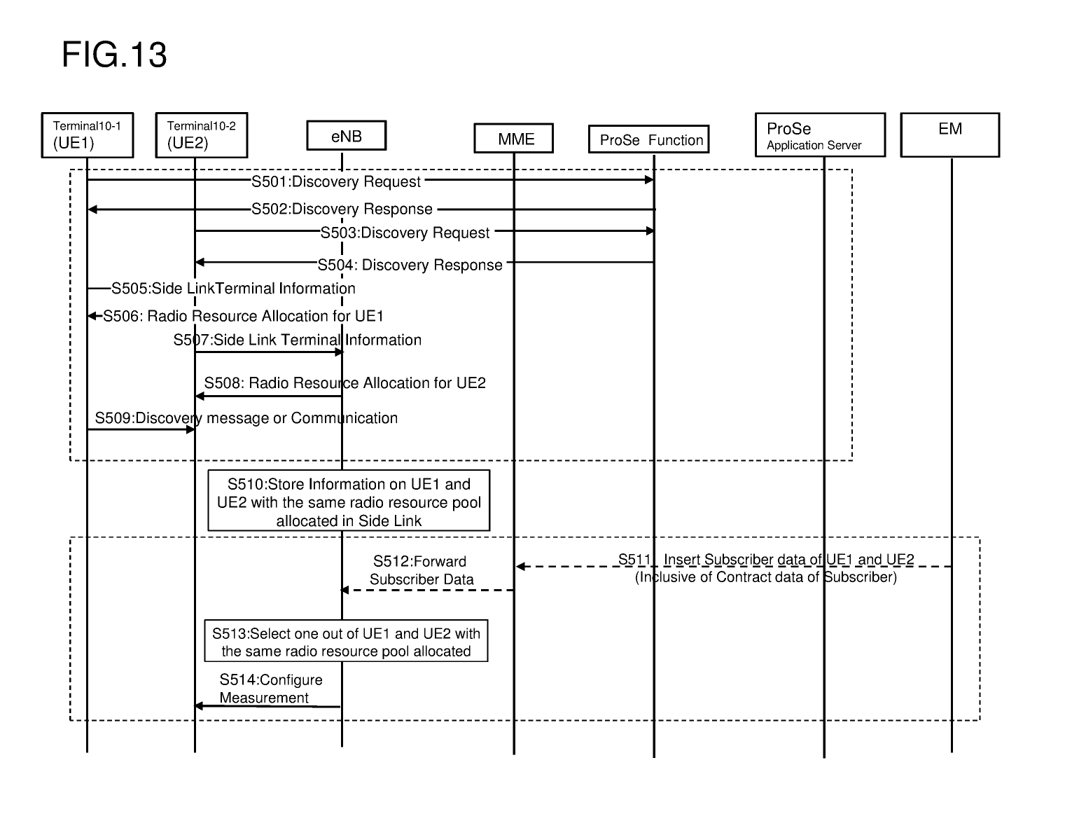

FIG. 13 is a diagram illustrating another example of the third example embodiment. FIG. 13 illustrates sequences in a case where ProSe direct discovery is applied to the present invention. Referring to FIG. 13, the terminal 10-1 (UE1) transmits a discovery request to the ProSe function (S501).

The ProSe function transmits a discovery response to the terminal 10-1 (UE1) (S502).

The terminal 10-2 (UE2) transmits a discovery request to the ProSe function (S503).

The ProSe function transmits a discovery response to the terminal 10-2 (UE2) (S504).

The terminal 10-1 (UE1) transmits side link terminal information (Sidelink UE information) including side link transmission resource request information (Sidelink Transmission Resource Request) to the base station 20 (eNB) (S505). A side link is a concept representing a link between terminals, while an uplink and a downlink represent links between a terminal and a base station, and in particular, is so called from a point of view of RAN (Radio Access Network). Therefore, ProSe may be called a side link. The side link corresponds to the PC 5 interface of the terminal to terminal communication in FIG. 11, for example. If the Prose related side link operation is authorized for the terminal, the terminal performs operations related to side link direct discovery (for example, transmission of a sidelink direct discovery announcement, and monitoring of the announcement) at a frequency allocated from the base station 20.

The eNB transmits configuration information (Sidelink communication configuration) of the radio resources used for the side link direct discovery to the terminal 10-1 (UE1) and allocates radio resources used for the discovery (S506). For example, the radio resource configuration information (Sidelink communication configuration) may be “discTxConfig” indicating configuration information of radio resources used for transmission (or announcement) of Sidelink (ProSe) direct discovery prescribed in Non-Patent Document 3 (3 GPP TS 36.331).

Further, the terminal 10-2 (UE2) transmits side link terminal information (Sidelink UE information) to the eNB (S 507). At this time, side link reception (or monitor) request information (Sidelink Reception/Monitoring Resource Request) which is information for requesting resources for side link reception (or monitoring) may be included in the side link terminal information (Sidelink UE Information).

Further, the side link terminal information (Sidelink UE Information) may include a request from the terminal for allocating or releasing radio resources for side link direct discovery, or information indicating that the terminal performs or performed transmission (announcement) or reception (or monitoring) of the discovery (Sidelink direct discovery). As a prerequisite of the transmission of the side link terminal information, the terminal may receive a system information block (SIB) type 18, 19, or the like notified from the eNB, and check necessary information in addition to the version or the like thereof.

The eNB transmits radio resource configuration information (Sidelink communication configuration) used for the side link direct discovery to the terminal 10-2 (UE2) and allocates radio resources (S508). Here, the radio resource configuration information (Sidelink communication configuration) used for the discovery may be information indicating a radio resource used for monitoring of Sidelink (ProSe) direct discovery. The information may be called “discRxConfig”.

The terminal 10-1 (UE1) transmits a discovery message to the terminal 10-2 (UE2) (S509).

The eNB stores information (for example, terminal ID or the like) of the terminals 10-1 and 10-2 (UE1, UE2) to which the same radio resource is allocated for side link direct discovery (S510). The eNB stores information (for example, terminal ID or the like) of the terminals 10-1 and 10-2 (UE1, UE2) that reported to the eNB that transmission (announcement) and/or reception (monitoring) of the discovery was performed with the same radio resource (S510).

Thereafter, if it is decided to cause the terminal 10 to execute MDT, subscriber data of a plurality of terminals including the terminals 10-1 and 10-2 (UE1, UE2) is inserted from the EM (for example, an HSS) to the MME (S511). Subscriber data may also include subscriber's consent information (User Consent) to MDT and subscriber contract information. In a case where the EM is an HSS, the subscriber data may be transmitted in “Insert Subscriber Data procedure” between HSS and MME (Non-Patent Document 5 (3 GPP TS 23. 401)).

The MME transfers the subscriber data to the eNB (S512). Here, the subscriber data may be transmitted, for example, in a “INITIAL CONTEXT SETUP REQUEST” performed by “Context Management procedures” between the MME and the eNB (Non-Patent Literature 6 (3 GPP TS 36.413)).

Out of the terminals 10-1 and 10-2 (UE1, UE2) that have reported to the eNB that the same radio resource has been allocated to the terminals, or that the terminals have performed transmission (announced) and/or reception (monitoring) of the discovery, one terminal (terminal 10-2) is selected (S513). In this case, the eNB may determine that the terminals 10-1 and 10-2 are in close proximity to make the selection.

The eNB transmits measurement configuration information to the terminal 10-2 (UE2) (S514). It is noted that the transmission of measurement configuration information (Logged Measurement Configuration) here may implicitly indicate an MDT activation instruction.

In a case where radio resources are allocated to the terminals 10-1 and 10-2 for the side link direct discovery, the eNB may also transmit configuration information designating a transmission power of the side link transmission. A distance between terminals is proportional to a transmission power required for communication between terminals that are parted by the distance. Therefore, by receiving information indicating that transmission (announcement) and/or reception (monitor) of discovery has been performed from the terminals 10-1 and 10-2, the distance between the terminals can be estimated based on a value of transmission power each set for the terminals 10-1 and 10-2.

The eNB may recognize that the terminals 10-1 and 10-2 to which the same radio resource have been allocated, or which have reported to the eNB that they have performed transmission (announcement) and/or reception (monitoring) of discovery, belong to the same group.

Although a case where the present invention is applied mainly to ProSe (Sidelink) discovery has been described in the present embodiment, the present invention may be applied to ProSe (Sidelink) direct communication (Direct Communication).

Further, storage of information by the eNB in step S510 of FIG. 13 may be performed as follows. For example, with respect to the terminals 10-1 and 10-2 (UE1, UE2) to which the same radio resource is allocated, the eNB may store the information as a table which associates identification information of radio resources (for example, information on a frequency direction and a time direction of a resource block) with terminal IDs of the respective terminals 10-1 and 10-2. Alternatively, the eNB may store the information as a table which associates at least one of the number of discovery performed between the terminals 10-1 and 10-2, a communication time of direct communication, and a value of transmission power used for discovery and direct communication, with terminal IDs of the terminal 10-1 and the terminal 10-2.

### Fourth Example Embodiment

A fourth example embodiment of the present invention will be described. A basic arrangement of a system of the fourth example embodiment is the same as that of FIG. 3. A core network 40 includes an MME (not shown) and is connected to an HSS (not shown). In the fourth embodiment, at least one terminal, which is caused to execute a measurement report, is selected based on contractor information of a plurality of terminals.

The contractor information may be referred to as “owner information”. The contractor information is different from so-called subscriber information (Subscriber data) stored in the HSS. The subscriber information (Subscriber data) is a one-to-one relationship with a terminal. On the other hand, one contractor information can be assigned to a plurality of terminals. The contractor information may be information (group ID) for grouping identifiers of terminals (subscriber information, IMSI (International Mobile Subscriber Identity), or the like). However, it is desirable that terminals in the same group are limited to terminals that have the same contractor or owner.

The contractor information can be transmitted from an HSS to an MME according to “Insert Subscriber Data procedure” described in Non-Patent Document 5 (3 GPP TS 23.401), for example. The subscriber information can be transmitted from an MME to a base station (eNB) by, for example, “INITIAL CONTEXT SETUP REQUEST” of “Context Management procedures” described in Non-Patent Document 6 (3GPP TS 36.413).

The contractor information may be a user account managed by a database such as a PCRF (Policy and Charging Rules Function) of an EPC. For example, when a user contracts a plurality of terminals, by managing terminal identification information (IMSI) in association with a user account by a PCRF or the like, it is possible to make charging and so forth common. It is also possible for a network side to determine that a plurality of terminals are owned by the same user (therefore, there is a high possibility that the terminals are used in proximity).

For example, at a time of attach processing of each terminal or the like, the base station (eNB) determines that a plurality of terminals belong to the same group from an identifier of each terminal, and when a plurality of terminals belong to the same group, the base station (eNB) may transmit a logged measurement configuration instruction to one terminal as a representative.

### <Example of Configuration of Each Apparatus>

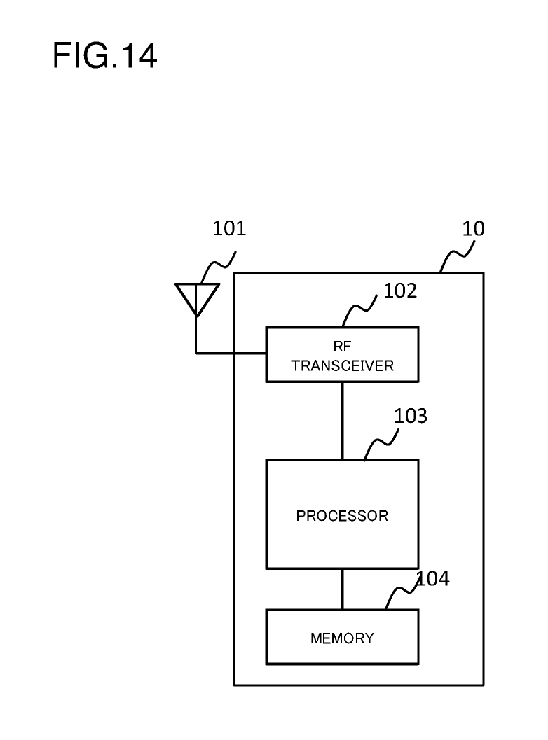

FIG. 14 is a diagram illustrating an example of a configuration of the terminal 10 according to the first and second example embodiments. The terminal 10 includes an antenna 101, an RF (Radio Frequency) transceiver (RF transceiver), a processor 103, and a memory 104. The number of processors 103 is, as a matter of course, not limited to one. For example, the processor 103 may include a communication controller (communication processor), a control system controller (processor), and the like, and the baseband processing may be performed by the processor 103. The terminal 10 may be a mobile phone terminal, a smartphone, a feature phone, a tablet terminal, or the like.

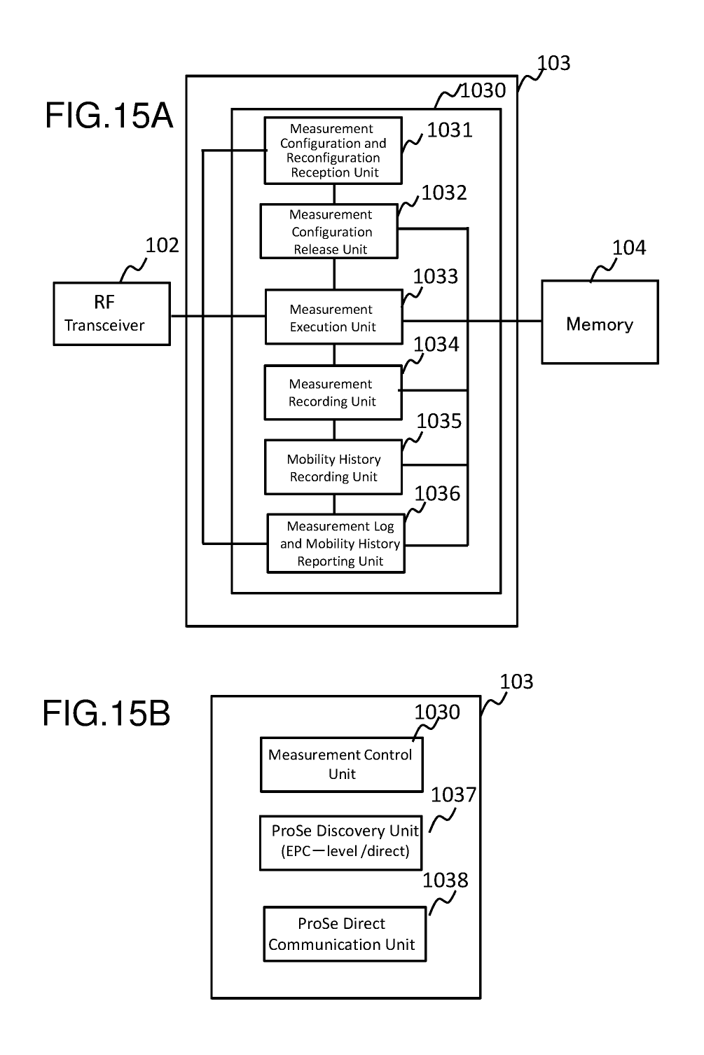

FIG. 15A is a diagram schematically illustrating a configuration of the measurement control unit 1030 that controls execution of MDT measurement and reporting in the processor 103. Referring to FIG. 15A, in the measurement control unit 1030 of the processor 103, a measurement configuration/reconfiguration reception unit 1031 receives measurement configuration (logged measurement configuration) and measurement re-configuration that are received by the RF transceiver 102 from the base station. A measurement configuration/release unit 1032 stores the measurement configuration in the memory 104 or deletes (releases) the measurement configuration stored in the memory 104, based on the received measurement configuration or reconfiguration information. A measurement execution unit 1033 executes measurement, based on the measurement configuration stored in the memory 104. A measurement recording unit 1034 records the measurement data measured by the measurement execution unit 1033 in the memory 104 in association with a measurement time and a measurement location. A mobility history recording unit 1035 records mobility history information (for example, a staying cell ID and a staying time) of the terminal 10 in the memory 104. A measurement log and mobility history reporting unit 1036 creates a measurement report from the measurement data recorded in the memory 104 and mobility history information. These units may be implemented by a program executed by the processor 103. In this case, the program stored in the memory 104 may be read out to a main memory or the like (not shown) of the processor 103 and executed.

FIG. 15B is a diagram illustrating another mode of the processor 103 of the terminal 10. The processor 103 in FIG. 15B corresponds to the aforementioned terminal (ProSe enabled UE). In addition to the measurement control unit 1030 of FIG. 15A, the processor 103 includes a ProSe discovery unit 1037 that finds a proximate terminal in an EPC level or directly and a ProSe direct communication unit 1038 that performs direct communication between terminals by a WLAN (wireless LAN (Local Area Network)) or the like such as Wi-Fi (registered trademark) (Wireless Fidelity) Direct.

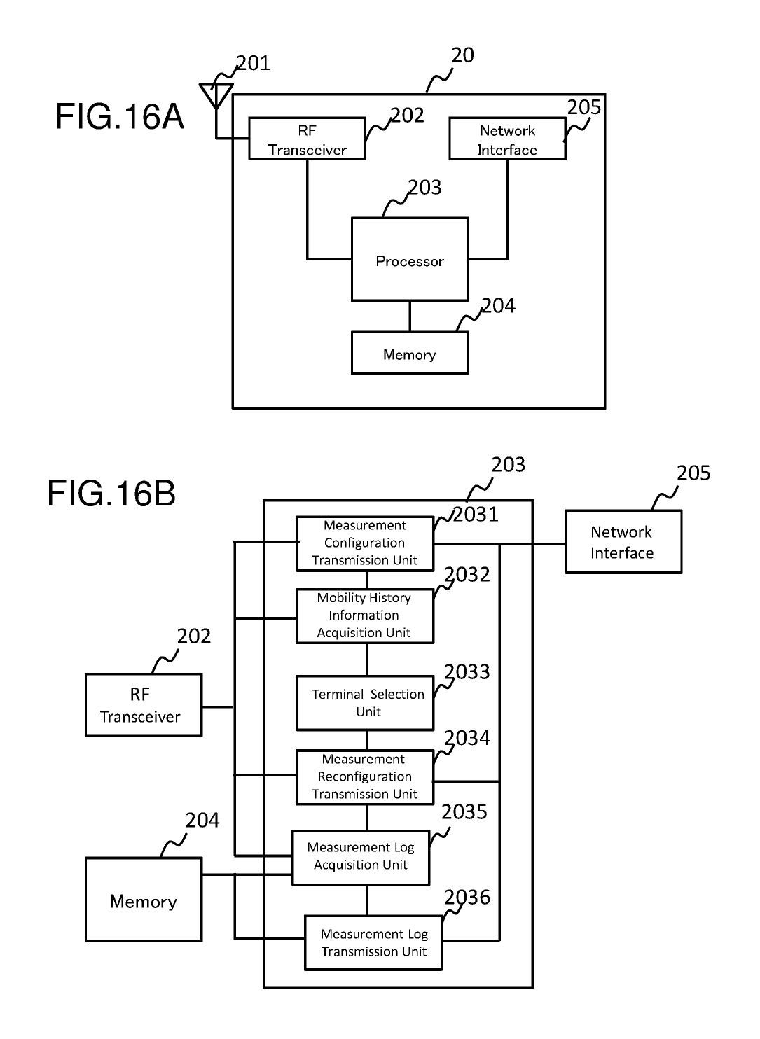

FIG. 16A is a diagram for schematically explaining a configuration of the base station 20. The base station 20 includes an antenna 201, a RF transceiver 202, a processor 203, a memory 204, and a network interface 205 that communicates with nodes (for example, MME and the like) of the core network (40 in FIG. The processor 203 implements.

FIG. 16B is a diagram illustrating a configuration of the processor 203 of the base station 20. A measurement configuration transmission unit 2031 receives MDT activation information from MME/SGSN via a network interface 205 and transmits measurement configuration information (Measurement Configuration) to a terminal via a transceiver 202. A mobility history information acquisition unit 2032 extracts mobility history information from the measurement report transmitted from the terminal and received by the RF transceiver 202. Based on the mobility history information and the like, a terminal selection unit 2033 selects a terminal from a plurality of terminals that satisfy a predetermined condition regarding proximity. A measurement reconfiguration transmission unit 2034 receives MDT activation information from the MME/SGSN via a network interface 205 and transmits to the terminal not selected (or selected) by the terminal selecting unit 2033, measurement reconfiguration via an RF transceiver 202. A measurement log acquisition unit 2035 acquires the measurement data from a measurement report transmitted from the terminal and received by the RF transceiver 202 and stores it in the memory 204. A measurement log transmission unit 2036 reads measurement data from the memory 204 and transmits the measurement data to a management server such as TCE via the network interface 205. Note that these units may be realized by programs executed by the processor 203. In this case, the program stored in the memory 204 may be read out to a main memory or the like (not shown) of the processor 203 and executed.

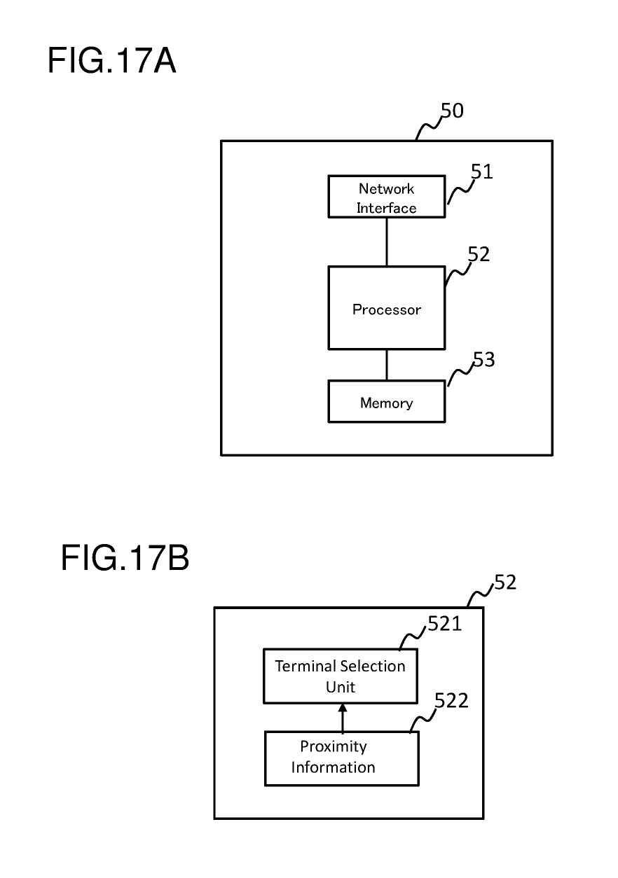

FIG. 17A is a diagram illustrating a network node (NW entity in FIG. 5). The network node 50 may include a network interface 51 that communicates with other network nodes (other entities or a base station in FIG. 6) of the core network (40 in FIG. 3), a processor 52, and a memory 53.

FIG. 17B is a diagram illustrating the processor 52. In the processor 52, a terminal selection unit 521 selects at least one terminal which is caused to execute measurement report, from among a plurality of terminals, based on information 522 for determining proximity of the plurality of terminals received from another network node via the network interface 51. Note that the terminal selection unit 521 may be implemented by a program executed on the processor 52. In this case, the program stored in the memory 53 may be read out to the main memory or the like (not shown) of the processor 52 and executed.

Further, in some of the above-described embodiments, a terminal that executes (or exempts) measurement, logging and reporting (MDT) may be selected based on battery information, corresponding frequency information, terminal capability information (UE-Capability Information) of a plurality of terminals having mutually proximity relationships.

In the above-described embodiments, a case where a plurality of terminals are wearable terminals, as an example of IoT devices, and the wearable terminals are worn by the same user, has been described. However, the present invention is not limited to this. For example, the present invention may be applied to a plurality of drone (unmanned aerial vehicle) equipped with a wireless communication function and flying while forming a team, and to a plurality of sensor nodes installed on a manufacturing line of a factory and used together.

The above-described embodiments may be annexed, for example, as follows (but, not limited to the following).

### (Supplementary Note 1)

A network node comprising:

a memory; and

a processor coupled to the memory, wherein

the processor is configured to:

collect information used for determining proximity of a plurality of terminals, and

select at least one terminal from among the plurality of terminals which is caused to execute a measurement report based on the collected information.

### (Supplementary Note 2)

The network node according to supplementary note 1, wherein the network node determines that the plurality of terminals are close to each other based on the collected information.

### (Supplementary Note 3)

The network node according to supplementary note 1 or 2, wherein the information used for determining the proximity includes at least one of:

mobility history information of the plurality of terminals;

information indicating a direct execution between the terminals by the plurality of terminals; and

contractor information of the plurality of terminals.

### (Supplementary Note 4)

The network node according to any one of supplementary notes 1 to 3, wherein the mobility history information includes at least one of:

an identifier of a cell or an identifier of a network in which the terminal stayed; and

a time at which the terminal stayed in the cell or the network.

### (Supplementary Note 5)

The network node according to any one of supplementary notes 1 to 4, wherein the information indicating execution of the terminal-to-terminal direct communication includes at least one of:

information on radio resources used for the terminal-to-terminal direct communication;

information indicating a counterpart of the terminal-to-terminal direct communication;

a value of transmission power used for the terminal-to-terminal direct communication; and

the number of times of communication or the communication time of the terminal-to-terminal direct communication.

### (Supplementary Note 6)

The network node according to any one of supplementary notes 1 to 5, wherein the processor is further configured to select at least one terminal that executes measurement report based on contractor information of the plurality of terminals.

### (Supplementary Note 7)

The network node according to any one of supplementary notes 1 to 6, further comprising

a transceiver, wherein

the processor is further configured to transmit, via the transceiver, measurement configuration information including information indicating that a measurement report is to be made on behalf of the plurality of terminals, to a terminal that is selected for executing measurement report.

### (Supplementary Note 8)

The network node according to any one of supplementary notes 1 to 6, further comprising

a transceiver, wherein

the processor is further configured to transmit, via the transceiver, information indicating releasing of preset measurement configuration information to a terminal other than the terminal that is selected for executing measurement report among the plurality of terminals.

### (Supplementary Note 9)

A communication system comprising:

a plurality of terminals; and

a network node, wherein

the network node includes at least:

a memory; and

a processor coupled to the memory, wherein

the processor is configured to:

collect information used for determining proximity of a plurality of terminals, and

select at least one terminal that executes measurement and reporting, from among the plurality of terminals, based on the collected information.

### (Supplementary Note 10)

The communication system according to supplementary note 9, wherein the network node determines that the plurality of terminals are close to each other based on the collected information.

### (Supplementary Note 11)

The communication system according to supplementary note 9 or 10, wherein the information used for determining the proximity includes at least one of:

mobility history information of the plurality of terminals;

information indicating a direct execution between the terminals by the plurality of terminals; and

contractor information of the plurality of terminals.

### (Supplementary Note 12)

The communication system according to any one of supplementary notes 9 to 11, wherein the mobility history information includes at least one of:

an identifier of a cell or an identifier of a network in which the terminal stayed; and

a time at which the terminal stayed in the cell or the network.

### (Supplementary Note 13)

The communication system according to any one of supplementary notes 9 to 12, wherein the information indicating execution of the terminal-to-terminal direct communication includes at least one of:

information on radio resources used for the terminal-to-terminal direct communication;

information indicating a counterpart of the terminal-to-terminal direct communication;

a value of transmission power used for the terminal-to-terminal direct communication; and

the number of times of communication or the communication time of the terminal-to-terminal direct communication.

### (Supplementary Note 14)

The communication system according to any one of supplementary notes 9 to 13, wherein the processor is configured to select at least one terminal that executes measurement report based on contractor information of the plurality of terminals.

### (Supplementary Note 15)

The communication system according to any one of supplementary notes 9 to 14, wherein the network node comprises

a transceiver, wherein

the processor is configured to transmit, via the transceiver, measurement configuration information including information indicating that a measurement report is to be made on behalf of the plurality of terminals, to a terminal that is selected for executing measurement report.

### (Supplementary Note 16)

The communication system according to any one of supplementary notes 9 to 15, further comprising

a transceiver, wherein

the processor is configured to transmit, via the transceiver, information indicating releasing of preset measurement configuration information to a terminal other than the terminal that is selected for executing measurement report among the plurality of terminals.

### (Supplementary Note 17)

A network control method for a network including:

a plurality of terminals; and

a network node, the method comprising:

the network node collecting information used for determining proximity of a plurality of terminals; and

selecting at least one terminal that executes measurement and reporting, from among the plurality of terminals, based on the collected information.

### (Supplementary Note 18)

The network control method according to supplementary note 17, wherein the network node determines that the plurality of terminals are close to each other based on the collected information.

### (Supplementary Note 19)

The network control method according to supplementary note 17 or 18, wherein the information used for determining the proximity includes at least one of:

mobility history information of the plurality of terminals; information indicating a direct execution between the terminals by the plurality of terminals; and

contractor information of the plurality of terminals.

### (Supplementary Note 20)

The network control method according to any one of supplementary notes 17 to 19, wherein the mobility history information includes at least one of:

an identifier of a cell or an identifier of a network in which the terminal stayed; and

a time at which the terminal stayed in the cell or the network.

### (Supplementary Note 21)

The network control method according to any one of supplementary notes 17 to 20, wherein the information indicating execution of the terminal-to-terminal direct communication includes at least one of: information on radio resources used for the terminal-to-terminal direct communication;

information indicating a counterpart of the terminal-to-terminal direct communication;

a value of transmission power used for the terminal-to-terminal direct communication; and

the number of times of communication or the communication time of the terminal-to-terminal direct communication.

### (Supplementary Note 22)

The network control method according to any one of supplementary notes 17 to 21, wherein the network node selects at least one terminal that executes measurement report based on contractor information of the plurality of terminals.

### (Supplementary Note 23)

The network control method according to any one of supplementary notes 17 to 22, comprising

the network node transmitting measurement configuration information including information indicating that a measurement report is to be made on behalf of the plurality of terminals, to a terminal that is selected for executing measurement report.

### (Supplementary Note 24)

The network control method according to any one of supplementary notes 17 to 22, further comprising

the network node transmitting information indicating releasing of preset measurement configuration information to a terminal other than the terminal that is selected for executing measurement report among the plurality of terminals.

### (Supplementary Note 25)

A non-transitory computer-readable medium storing therein a program causing a computer constituting a network node to execute processing comprising:

collecting information used for determining proximity of a plurality of terminals; and

selecting at least one terminal that executes measurement and reporting from among the plurality of terminals based on the collected information.

### (Supplementary Note 26)

A terminal comprising:

a transceiver configured to receive a measurement configuration, or a measurement re-configuration from a network node that operates to select at least one terminal that executes measurement and reporting, from among a plurality of terminals, based on information used for determining proximity of the plurality of terminals; and

a processor configured to perform measurement based on the received measurement configuration, or the received measurement re-configuration.

### (Supplementary Note 27)

The terminal according to supplementary note 26, wherein the information used for determining the proximity includes at least one of:

mobility history information of the plurality of terminals;

information indicating a direct execution between the terminals by the plurality of terminals; and

contractor information of the plurality of terminals.

### (Supplementary Note 28)

The terminal according to any one of supplementary note 26, wherein the information indicating execution of the terminal-to-terminal direct communication includes at least one of:

information on radio resources used for the terminal-to-terminal direct communication;

information indicating a counterpart of the terminal-to-terminal direct communication;

a value of transmission power used for the terminal-to-terminal direct communication; and

the number of times of communication or the communication time of the terminal-to-terminal direct communication.

The disclosure of each of the above Patent Literatures 1-3 and Non-Patent Literatures 1-6 is incorporated herein by reference thereto. Variations and adjustments of the Exemplary embodiments and examples are possible within the scope of the overall disclosure (including the claims) of the present invention and based on the basic technical concept of the present invention. Various combinations and selections of various disclosed elements (including the elements in each of the claims, examples, drawings, etc.) are possible within the scope of the claims of the present invention. Namely, the present invention of course includes various variations and modifications that could be made by those skilled in the art according to the overall disclosure including the claims and the technical concept.

1. A network node comprising:
a memory; and
a processor coupled to the memory, wherein
the processor is configured to:
collect information used for determining proximity of a plurality of terminals, and
select at least one terminal from among the plurality of terminals which is caused to execute a measurement report based on the collected information.

2. The network node according to claim 1, wherein the network node determines that the plurality of terminals are close to each other based on the collected information.

3. The network node according to claim 1, wherein the information used for determining the proximity includes at least one of:
mobility history information of the plurality of terminals;
information indicating an execution of terminal-to-terminal direct communication by the plurality of terminals; and
contractor information of the plurality of terminals.

4. The network node according to claim 3, wherein the mobility history information includes at least one of:
an identifier of a cell or an identifier of a network in which the terminal stayed; and
a time at which the terminal stayed in the cell or the network.

5. The network node according to claim 3, wherein the information indicating execution of the terminal-to-terminal direct communication includes at least one of:
information on radio resources used for the terminal-to-terminal direct communication;
information indicating a counterpart of the terminal-to-terminal direct communication;
a value of transmission power used for the terminal-to-terminal direct communication; and
the number of times of communication or the communication time of the terminal-to-terminal direct communication.

6. The network node according to claim 3, wherein the processor is further configured to select at least one terminal that executes measurement report based on contractor information of the plurality of terminals.

7. The network node according to claim 1, further comprising
a transceiver, wherein
the processor is further configured to transmit, via the transceiver, measurement configuration information including information indicating that a measurement report is to be made on behalf of the plurality of terminals, to a terminal that is selected for executing measurement report.

8. The network node according to claim 1, further comprising
a transceiver, wherein
the processor is further configured to transmit, via the transceiver, information indicating releasing of preset measurement configuration information to a terminal other than the terminal that is selected for executing measurement report among the plurality of terminals.

9. A communication system comprising:
a plurality of terminals; and
a network node, wherein
the network node includes at least:
a memory; and
a processor coupled to the memory, wherein
the processor is configured to:
collect information used for determining proximity of a plurality of terminals, and
select at least one terminal that executes measurement and reporting, from among the plurality of terminals, based on the collected information.

10. The communication system according to claim 9, wherein the information used for determining the proximity includes at least one of:
mobility history information of the plurality of terminals;
information indicating a direct execution between the terminals by the plurality of terminals; and
contractor information of the plurality of terminals.

11. The communication system according to claim 10, wherein the mobility history information includes at least one of:
an identifier of a cell or an identifier of a network in which the terminal stayed; and
a time at which the terminal stayed in the cell or the network.

12. The communication system according to claim 10, wherein the information indicating execution of the terminal-to-terminal direct communication includes at least one of:
information on radio resources used for the terminal-to-terminal direct communication;
information indicating a counterpart of the terminal-to-terminal direct communication;
a value of transmission power used for the terminal-to-terminal direct communication; and
the number of times of communication or the communication time of the terminal-to-terminal direct communication.

13. A network control method for a network including:
a plurality of terminals; and
a network node, the method comprising:
the network node collecting information used for determining proximity of a plurality of terminals; and
selecting at least one terminal that executes measurement and reporting, from among the plurality of terminals, based on the collected information.

14. A non-transitory computer-readable medium storing therein a program causing a computer constituting a network node to execute processing comprising:
collecting information used for determining proximity of a plurality of terminals; and
selecting at least one terminal that executes measurement and reporting from among the plurality of terminals, based on the collected information.

15. A terminal comprising:
a transceiver configured to receive a measurement configuration, or a measurement re-configuration from a network node that operates to select at least one terminal that executes measurement and reporting, from among a plurality of terminals, based on information used for determining proximity of the plurality of terminals; and
a processor configured to perform measurement based on the received measurement configuration, or the received measurement re-configuration.
